(19) United States
(12) Patent Application Publication
(10) Pub. No.: US 2007/0005481 A1
(43) Pub. Date: Jan. 4, 2007

(54) Real time graphical user interface for on-line trading

(76) Inventors: Vijay Kedia, Manhasset, NY (US); Bertrand Rassat, London (GB); Vikas S. Kedia, London (GB)

Correspondence Address: John M. Johnson;Carter Ledyard & Milburn LLP, 2 Wall Street, New Jersey, NY, 10005, US

(21) Appl. No.: 11/169,941

(22) Filed: Jun. 29, 2005

(51) Int. Cl. G06Q 40/00

(52) U.S. Cl. 705/37

(57) ABSTRACT

A system and method for displaying on a graphical user interface at least one of stock and other equity type information for trade related actions by a user with an electronic exchange, said displaying being configurable by said user, comprising graphically displaying and updating in substantially real time in a first portion of said graphical user interface historical filled order data; graphically displaying and updating in substantially real time in a second portion of said graphical user interface current unfilled order data; graphically displaying said trade related actions made on said graphical user interface by said user; graphically displaying modifications made on said graphical user interface to said trade related actions by said user; and allowing variation by said user of physical dimension of at least one of said first portion and said second portion of said graphical user interface. Depth price bands graphically display the real-time depth of the market i.e. the available volume at a particular price. Historical depth of market snapshots, including periodic snapshots, simple average snapshots, weighted average and Max-Min-Open-Close snapshots, can be graphically shown along with real time market data.

### BACKGROUND OF THE INVENTION

The present invention pertains to on-line trading of equities such as, for example, stocks. The invention more specifically relates to a graphical user interface for on-line trading that allows real-time trading and provides trade-data to the user in configurable and easily comprehendible formats.

United States Patent Application Publication No. US 2002/0099422 to Kemp, II et al. provides a method and system for reducing the time it takes for a trader to place a trade when electronically trading on an exchange, thus increasing the likelihood that the trader will have orders filled at desirable prices and quantities. The “Mercury” display and trading method of the present invention ensure fast and accurate execution of trades by displaying market depth on a vertical or horizontal plane, which fluctuates logically up or down, left or right across the plane as the market prices fluctuate. This allows the trader to trade quickly and efficiently. The price consolidation feature of the present invention, as described herein, enables a trader to consolidate a number of prices in order to condense the display. Such action allows a trader to view a greater range of prices and a greater number of orders in the market at any given time. By consolidating prices, and therefore orders, a trader reduces the risk of a favorable order scrolling from the screen prior to filling a bid or ask on that order at a favorable price.

United States Patent Application Publication No. US 2004/0153393 to West et al. provides a system and method for displaying a plurality of profit and risk related indicators are described. A graphical interface displays and dynamically updates a plurality of profit/loss (P/L) indicators including a realized, net, and open indicator. The net and open indicators are based on a trader's net position and a current market level, while the realized indicator is based on trader's buys and sells associated with a tradable objects. In one embodiment, the plurality of indicators are displayed in relation to a plurality of money management regions defining a maximum order quantity and a maximum net position controlling the trader's trades, so that a trader can quickly determine his current as well as potential money management parameters. The graphical interface may also display a plurality of potential risk/gain indicators in relation to a realized profit indicator so that a trader, before entering an order having a predetermined order quantity, can view a potential risk/gain in entering into a predetermined net position in view of potential market movements.

United States Patent Application Publication No. US 2003/0004853 to Ram et al. provides an interactive graphical front end system for use in trading securities provides a GUI display where buy and sell orders at specific prices for any selected security at any instant in time are displayed, and where the data is displayed for more than one market trading participant. The graphical front end is used by any trader who buys and sells securities in real time; the graphical interface permits the use of active cells on the display to instruct and complete a buy or sell order of any security at any price, at any instant in time when the data for that security is being displayed. Appropriate protocols are employed, along with the necessary translators, for transparent trading action from the viewpoint of the trader; who is able to track his holdings and cash position at any instant in time.

United States Patent Application Publication No. US 2002/0120551 to Jones, III provides a visual-kinesthetic system for financial trading is disclosed. The system includes a computer with at least one screen that has both input and output capabilities, graphical software controllable by input to the computer that follows and plots the movement of financial information in a market to the input/output screen, and trading software controllable by the computer and by input from the screen that functionally communicates with the graphical software so that interaction with graphical information on the screen can control the trading software.

U.S. Pat. Nos. 6,772,132 and 6,766,304 to Kemp, II et al. provide a method and system for reducing the time it takes for a trader to place a trade when electronically trading on an exchange, thus increasing the likelihood that the trader will have orders filled at desirable prices and quantities. The “Mercury” display and trading method of the present invention ensure fast and accurate execution of trades by displaying market depth on a vertical or horizontal plane, which fluctuates logically up or down, left or right across the plane as the market prices fluctuates. This allows the trader to trade quickly and efficiently.

U.S. Pat. No. 5,297,031 to Gutterman et al. provides broker workstation for managing orders in a market for trading commodities, securities, securities options, futures contracts and futures options and other items including: a device for selectively displaying order information; a computer for receiving the orders and for controlling the displaying device; and a device for entering the orders into the computer; wherein the displaying device comprises a device for displaying selected order information about each incoming order, a device for displaying a representation of an order deck and a device for displaying a total of market orders. In another aspect of the invention, there is provided in a workstation having a computer, a device for entering order information into the computer and a device for displaying the order information entered, a method for managing orders in a market for trading commodities, securities, securities options, futures contracts and futures options and the like comprising the steps of: selectively displaying order information incoming to the workstation; accepting or rejecting orders corresponding to the incoming order information displayed; displaying accepted order information in a representation of a broker deck; and selectively displaying a total of orders at the market price.

United States Patent Application Publication No. US 2004/0103054 to Singer provides a trading screen that may display price and quantity information for price levels in a static axis of prices. The static axis of prices may be divided into two or more different regions. The price and quantity information for one or more of the regions may be consolidated from price and quantity information from plurality of unconsolidated price levels.

United States Patent Application Publication No. US 2003/0065608 to Cutler provides a method, system and computer program to monitor securities market activity to seek out imbalances in market activity that could lead to a price change in a particular security. Level 2 data is analyzed to track the activity of market makers and to derive an indicator of momentary upward or downward price pressure. The indicator associated with each selected security is displayed to a user.

United States Patent Application Publication No. US 2003/0004852 to Burns provides an electronic spread trading tool to be used when buying and selling comparable commodities either simultaneously or in conjunction with one another. The spread trading tool involves a method of displaying, on an electronic display device, the market depth of a plurality of commodities including an anchor commodity and a non-anchor commodity, where the method includes dynamically displaying a plurality of bids and asks in the market for the commodities, statically displaying prices corresponding to those plurality of bids and asks, where the bids and asks are displayed in alignment with the prices corresponding thereto, displaying an anchor visual indicator corresponding to and in alignment with a desired price level of the anchor commodity, displaying a price level indicator corresponding to and in alignment with a price level of the non-anchor commodity. Based on an unhedged position, and taking into account the parameters and spread price point values, as determined by the trader, price level indicators are calculated and displayed, which provide a visual representation of where the trader should buy and sell the applicable commodities. The price level for the price level indicator in the non-anchor commodity is determined based upon said desired price level of the anchor commodity. The price level indicator also includes a first visual indicator corresponding to and in alignment with a first price level of the non-anchor commodity and a second visual indicator corresponding to and in alignment with a second price level of the non-anchor commodity.

United States Patent Application Publication No. US 2002/0184237 to McFeely provides a system for distributing data describing trading activity occurring on a plurality of different Electronic Communications Networks (ECNs), each of which receives buy and sell orders from stock traders and each of which performs equity sales transactions based on the received orders. Live data fed from each ECN describing pending buy and sell orders and executed transactions on each exchange are reformatted into standard form and aggregated to create, update and maintain consolidated trading data that is stored in a database. In response to one or more request specifications received from a remotely located user, the system extracts and processes selected portions of the consolidated data to produce response data returned to the requestor. This requested data may include streaming ticker tape and stock status data describing the status of all or a selected subset of stocks being actively traded on the multiple ECNs; an index value representative of the current selling price of a predetermined group of securities being traded on the multiple ECNs, depth-of-book data describing the current best pending offers to buy and sell one or more selected securities, and news stories concerning the securities being traded, including artificially generated natural language text news which is automatically produced by items of consolidated ECN data that satisfies predetermined conditions which define “newsworthy” events.

In United States Patent Application Publication No. US 2002/0178105 to Levine system and methods are provided to facilitate a display of investment information associated with a plurality of share prices. According to one embodiment, an amount of shares bid associated with each of a plurality of bid prices is determined for an investment. An amount of shares offered associated with each of a plurality of ask prices is also determined for the investment. It is then arranged for indications of the amounts of shares bid and the amounts of shares offered to be graphically displayed. For example, an investment chart may include lines that represent a number of stock shares bid for each of a plurality of bid prices and a number of stock shares offered for each of a plurality of ask prices so as to provide an investor with a direct sense of market depth associated with the investment.

United States Patent Application Publication No. US 2002/0073017 to Robertson provides a method and system of presenting data and analysis for use in stock market trading. The method includes the steps of receiving stock information from a stock data provider, and then analyzing the stock information to generate historical stock trading information. Graphical displays showing the historical stock trading information along with basic stock information are then generated in such a manner to facilitate rapid understanding of the information being displayed.

United States Patent Application Publication No. US 2002/0055899 to Williams provides system and method for displaying and organizing highly complex and voluminous financial information pertaining to stock market trading activity on a computer display terminal in a manner that permits an individual to easily monitor and assimilate the information. The system forms a visual display which organizes and presents the trading information for a selected stock in a number of independent regions on a computer display terminal. A user can choose to display information pertaining to a number of user-defined stocks from a plurality of tabs along an upper edge of the display. For any stock selected, ask and bid sales and volume information for all of the auction participants for the selected stock can be displayed along with post trade information. Other significant information pertaining the trading positions of the auction participants is readily discernable from changes in color of the tabs designating those auction participants. Still other regions of the display allow the user to replay all previous activity information for the selected stock or to view pertinent post-trade analytical information concerning the stock. The system and method enable non-professional individuals to more easily discern trends in the activity of those stocks important to the user as well as to more quickly discern important trends in the trading activities of the auction participants for each of those stocks.

U.S. Pat. No. 6,134,535 to Belzberg provides an improvement in computer automated stock exchange trading whereby a graphic user interface with a mouse and display is used to select parameters such as share symbol, price selection, order size, and transaction type, as well as other indicators to launch a trading order to the order entry system of a stock exchange computer. Further improvements include a programmed interface by which data on a group of shares may be read from a spreadsheet formulated into an order and launched automatically or in response to a signal from an operator so as to trade an index or basket of shares substantially instantaneously.

U.S. Pat. No. 5,297,032 to Trojan et al. provides a work station for use by a trader of securities on an established market. The work station is integrated into a network of competing market makers for a plurality of securities for trading. A centralized database provides a feed of data on current market events for the securities, including price and transaction data. The work station is specifically programmed to receive the feed of data from the database and convert this datastream into a form conducive to enhanced trading. Seven separate applications permit the trader to track the market, select securities, bid and ask pricing, market direction and market depth. Traders equipped with the workstation are capable of entering transactions with more complete and copious knowledge about the extant market.

United States Patent Application Publication No. US 2002/0023038 to Fritsch et al. provides an auction system and method is disclosed which displays a graphical representation of a buy bid, ask bid and a series of incremental bids therebetween along a scale. A user may enter a new bid by moving the computer screen cursor to a position on the scale and initiating an entry command. The system then reconfigures the scale to reflect the newly entered bid should the spread between the buy bid and ask bid reach a select level the incremental bids are reassociated with a decreased monetary value and possibly reconfigured in the quantity of incremental bids within the spread.

United States Patent Application Publication No. US 2002/0138401 to Allen et al. provides a securities transaction, such as a buy or sell order is transmitted to a securities exchange with an indicator requesting automatic execution. In one embodiment, the securities transaction has a limit price and if the limit price is equal to or better than the current quote for the security on the exchange, the transaction is automatically executed without exposing the transaction to the auction market crowd on the exchange floor for possible price improvement. In another embodiment, the securities transaction is a market order, and if otherwise eligible, the transaction is automatically executed without exposing the transaction to auction market crowd on the exchange floor for possible price improvement.

U.S. Pat. No. 4,674,044 to Kalmus et al. provides data processing based apparatus makes an automated trading market for one or more securities. The system retrieves the best obtaining bid and asked prices from a remote data base, covering the ensemble of institutions or others making a market for the relevant securities. Data characterizing each securities buy/sell order requested by a customer is supplied to the system. The order is qualified for execution by comparing its specifics against predetermined stored parameters. The stored parameters include the operative bid and asked prices, the amount of stock available for customer purchase or sale, and maximum single order size. Once qualified, the order is executed and the appropriate parameters are updated. The system provides inventory (position) control and profit accounting for the market maker. Finally, the system reports the executed trade details to the customer, and to national stock price reporting systems. Upon a change in the quoted price for a security, the system updates all relevant qualification parameters.

In U.S. Pat. No. 4,750,135 to Boilen, a local subscriber defines its own filter sets and/or local templates which are used to create new updateable local trading instrument displayable data records from a common remotely transmitted data stream of trading instrument data records, which are user created reconstituted data records different from the transmitted trading instrument data records. A common one of the defined filter sets and/or local templates may be used for a plurality of different data records having a common desired set of information categories. The transmitted data may be in a logical data format or a page display format, in which instance it is converted to a logical data format. The local template is used to convert page display data to logical data and may be repetitively used on different display rows of a given page display and/or on different page displays to provide a plurality of receiver defined locally created trading instrument display records so that only the information desired by the local subscriber is displayed on his screen as user defined local trading instruments.

U.S. Pat. No. 4,903,201 to Wagner provides a computerized open outcry exchange system for transacting sales of a particular futures commodity contract by members of a futures trading exchange wherein bids to purchase or offers to sell the particular commodity contract are made by the members through remote terminals and the exchange computer automatically matches offers and bids to complete the transaction.

U.S. Pat. No. 5,038,284 to Kramer provides a central computer equipped with communications hardware and specially designed software receives transaction data from personal transaction stations operated by traders, sends back verification information to the traders, reconciles all trades, informs traders when an error occurs, generates complete records of all transactions, reports price and volume data to quote vendors, provides numerous reports which analyze trading activity to detect potential regulatory violations, creates a complete real-time backup copy of all data, and provides intraday profit, loss, risk, and margin information to exchange and Futures Commission Merchant personnel.

In U.S. Pat. No. 5,077,665 to Silverman et al. a matching system for trading instruments is provided in which bids are automatically matched against offers for given trading instruments for automatically providing matching transactions in order to complete trades for the given trading instruments in which controllable subsets of a distributable system trading book may be selectively provided to trading keystations in the matching system from the host computer or central system for dynamically controllably masking the available trading market. The system comprises the host computer for maintaining a host book data base comprising all of the active bids and offers in the system by trading instrument, a transaction originating keystation at a client site for providing a bid on a given trading instrument to the system for providing a potential matching transaction, a counterparty keystation for providing an offer on the given trading instrument involved in the potential matching transaction, and a network for interconnecting the host computer, the transaction originating keystation and the counterparty keystation in the system for enabling data communication therebetween. Both the transaction originating keystation and the counterparty keystation each have an associated local data base keystation book comprising a subset of the host book. The content of each of the keystation books has an associated display depth range which is dynamically controllable by the host computer and is dynamically updatable by transaction update broadcast messages received from the host computer through the network which is preferably transparent to the transactions communicated.

U.S. Pat. No. 5,101,353 to Lupien et al. provides an automated system for managing one or more large investor portfolios containing both cash and numerous, diversified securities in a real time environment provides added liquidity to the securities markets while maintaining predetermined portfolio objectives for each portfolio. The disclosed system uses data processing equipment to place buy and sell orders on securities markets and with automated brokers to execute trade directly between users of the system and external markets. Holders of such large, diversified portfolios have usually been long-term investors. The system allows active market participation by such investors whereby they provide added liquidity and depth to the securities markets while overcoming problems caused by trader identification and the inability to enter, change or execute orders in a real time environment. The system monitors and analyzes a variety of factors which effect trading decisions in a vast number of securities. Such factors include other security trades, price and size quotations and financial ratios for particular securities. This information is further analyzed in relationship to each investor portfolio using the system to determine what transactions might benefit the portfolio by seeking to provide an incremental return while accommodating the basic portfolio objectives. These objectives may be changed at the election of the investor at any time. Orders representing such transactions are entered by the system and executed in real time either internally between system users or externally with computerized brokers and/or stock exchanges and markets.

U.S. Pat. No. 5,136,501 to Silverman et al. provides a matching system for trading instruments in which bids are automatically matched against offers for given trading instruments for automatically providing matching transactions in order to complete trades for the given trading instruments, includes a host computer means comprising means for anonymously matching active bids and offers in the system by trading instrument based on a variable matching criteria, which comprises counterparty credit limit between counterparties to a potential matching transaction. The system also includes a transaction originating keystation for providing a bid on a given trading instrument to the system for providing the potential matching transaction; a counterparty keystation for providing an offer on the given trading instrument involved in the potential matching transaction; and network means for interconnecting the host computer means, the transaction originating keystation and the counterparty keystation in the system for enabling data communications therebetween. Both the transaction originating keystation and the counterparty keystation for the potential matching transaction each have an associated counterparty credit limit, with the system blocking completion of the potential matching transaction between the transaction originating keystation and the counterparty keystation means when the potential matching transaction has an associated value in excess of counterparty credit limit. The assigned credit limits may be reset or varied by the users to change the ability of the user or subscriber to effectuate deals.

In U.S. Pat. No. 5,270,922 to Higgins a data processing and communication system distributes and displays financial market ticker, quotation, news and ancillary information via a plurality of stored program controlled work stations. Stock trade executions, quotations and other ticker plant information is communicated in parallel to a hierarchy of system data processing terminals, e.g., those located at area, branch and individual work station locations. Storage media at the several system data processing levels extracts and stores data base information of differing purport and completeness for the disseminated data to support the system work station users. In accordance with one aspect of the present invention, information characterizing a dynamically changing sub-population of the overall ensemble of market securities is maintained at and becomes immediately available to each work station responsive to the pattern of usage at that specific station. Various derivative tasks, such as security price limit alerts, are user programmable and are activated by the contents of the work station data base.

U.S. Pat. No. 5,689,651 to Lozman provides a system for processing and displaying financial market data corresponding to user selected primary and secondary symbols having a programmable computer with a display. A communication device is connected to the computer for receiving the financial market data from an external data source. The computer has software for selecting the primary and secondary symbols from the financial market data and for displaying the data corresponding to the primary symbol on a central portion of the display and displaying the data corresponding to the secondary symbols on a peripheral portion of the display and periodically updating the data corresponding to the selected primary and secondary symbols.

U.S. Pat. No. 5,774,877 to Patterson, Jr. et al. provides a method of managing the activities of one or more floor brokers situated on the floor of an exchange is disclosed. In one respect, the method uses a programmed computer to compare a relative number of instructions having a pending status that have been delegated to the floor brokers and find the floor broker having comparatively few pending instructions. The computer then delegates a further instruction to the floor broker that has been found. Typical instructions that may be managed by the inventive method may be quotation requests, quotations, orders, partial executions, and executions. A related method enables an operator to delegate instructions to one of plural floor brokers by providing the operator with a computer and the floor brokers with two-way communication devices and by receiving at the operator's computer current-status information on any delegated instructions and automatically displaying that information at the computer.

U.S. Pat. No. 5,793,301 to Patterson, Jr. et al. provides a method for providing assured communications in a two-way wireless communications system is disclosed. An instruction is constructed at a first device for wireless transmission to a second device where the instruction is received by the second device and ultimately seen by the user. The instruction is transmitted as an instruction signal. The second device alters the instruction signal and transmits it back in altered form to provide an indication that the instruction has been received by the second device. The user of the second device informs the operator of the first device that the instruction has been seen by the user by transmitting a further altered version of the instruction signal to the first device. The disclosed method assures the operator of the first device that instructions are being received and acknowledged in a timely manner.

In U.S. Pat. No. 5,797,002 to Patterson, Jr. et al. a data structure is disclosed for use in a two-way wireless system for processing equity trades and the like. The data structure is stored in a computer-readable memory and includes information used by an application program. The data structure comprises a plurality of data packets, each of which contains the information used by the application program as well as a sequence code and a volley code. The sequence code associates a subset of the data packets together. The volley codes defines a hierarchical relationship among the subject of data packets. An order data packet has a hierarchical level that differs from that of an one or more execution data packets. A many-to-one relationship exists between the execution data packets and the order data packet. Each execution data packet has an execution sequence number uniquely assigned by the application program. A two-way wireless system using such a data structure is also disclosed.

U.S. Pat. No. 5,845,266 to Lupien et al. provides a crossing network that matches buy and sell orders based upon a satisfaction and quantity profile includes a number of trader terminals that can be used for entering orders. The orders are entered in the form of a satisfaction density profile that represents a degree of satisfaction to trade a particular instrument at various (price, quantity) combinations. Typically, each order is either a buy order or a sell order. The trader terminals are coupled to a matching controller computer. The matching controller computer can receive as input the satisfaction density profiles entered at each one of the trading terminals. The matching controller computer matches orders (as represented by each trader's satisfaction density profile) so that each trader is assured that the overall outcome of the process (in terms of average price and size of fill) has maximized the mutual satisfaction of all traders. Typically, the matching process is anonymous. The matching process can be continuous or a batch process, or a hybrid of the two. Unmatched satisfaction density profiles can be used to provide spread and pricing information. Factors other than price and quantity also may be used to determine the degree of satisfaction. Optionally, priority may be given to certain profiles in the matching process to accommodate stock exchange rules, for example, requiring that priority be given to orders exhibiting the best price, regardless of size or any other consideration.

U.S. Pat. No. 5,915,245 to Patterson, Jr. et al. a method of managing the activities of one or more floor brokers situated on the floor of an exchange is disclosed. In one respect, the method uses a programmed computer to compare a relative number of instructions having a pending status that have been delegated to the floor brokers and find the floor broker having comparatively few pending instructions. The computer then delegates a further instruction to the floor broker that has been found. Typical instructions that may be managed by the inventive method may be quotation requests, quotations, orders, partial executions, and executions. A related method enables an operator to delegate instructions to one of plural floor brokers by providing the operator with a computer and the floor brokers with two-way communication devices and by receiving at the operator's computer current-status information on any delegated instructions and automatically displaying that information at the computer.

U.S. Pat. No. 5,924,082 to Silverman et al. provides a negotiated matching system includes a plurality of remote terminals associated with respective potential counterparties, a communications network for permitting communication between the remote terminals, and a matching station. Each user enters trading information and ranking information into his or her remote terminal. The matching station then uses the trading and ranking information from each user to identify transactions between counterparties that are mutually acceptable based on the ranking information, thereby matching potential counterparties to a transaction. Once a match occurs, the potential counterparties transmit negotiating messages to negotiate some or all terms of the transaction. Thus, the negotiated matching system first matches potential counterparties who are acceptable to each other based on trading and ranking information, and then enables the two counterparties to negotiate and finalize the terms of a transaction.

U.S. Pat. No. 5,924,083 to Silverman et al. provides a distributed electronic trading system for displaying a real-time credit filtered view of at least one market in which financial instruments are traded in which the market view includes a predetermined number of orders currently available to a viewing trading entity based upon one or more credit limits entered by the viewing trading entities and/or other trading entities in the system includes a host for receiving and storing orders and credit information entered by a plurality of trading entities including the viewing trading entity, for transmitting the orders and predetermined display parameters, and for selectively transmitting the credit information; a plurality of intelligent nodes linked to the host; and a plurality of keystations respectively linked to one or more of the intelligent nodes. Each intelligent node includes a credit information storage unit for storing the selected credit information, an order book storage unit for storing the orders and display parameters, and a processor for generating real-time credit filtered market view display information for each assigned trading entity. The real-time credit filtered market view display information includes the predetermined number of unilaterally and/or bilaterally credit filtered orders and corresponding available quantities. The displayed market view may consist of individual order prices and quantities, aggregated prices and quantities, and/or average prices at predetermined quantities chosen by the viewing trading entity.

In U.S. Pat. No. 5,946,667 to Tull, Jr. et al. a data processing system and method is disclosed for implementing and control of a financial debt instrument which is issued for a limited period of time and is traded as a listed security. The debt instrument is based on an underlying basket of stocks optimally selected to track an established capital market and its price also reflects accrued investment income and maintenance expenses. The data processing system receives input from the capital market and periodically evaluates the performance of the financial debt instrument, reporting its price to customers. Also disclosed is a data processing system for administering an investment group of such debt instruments designed to track the performance of several domestic and foreign markets, estimate their return and provide current price information to customers.

U.S. Pat. No. 5,963,923 to Garber provides a system and method is provided for linking a Rolling Spot Currency contract with a Principle Market Maker program. In one aspect of the invention, the system includes an electronic brokerage and trading network having at least one computer coupled to receive and transmit bids and offers for international currency trading; a display terminal and input; and a principal market maker computer coupled to the electronic brokerage and trading network wherein the principal market maker computer is operative to receive and transmit the bids and offers and execute international currency trades by maintaining a market for such currencies. In another aspect of the invention, the method includes the steps of receiving and transmitting bids and offers for publicly traded currencies; storing the received bids and offers in a memory; identifying and executing the matching bids and offers; and identifying unmatched bids and offers and providing a complementary trade to maintain a market for such currencies.

In U.S. Pat. No. 6,012,046 to Lupien et al. a crossing network that matches buy and sell orders based upon a satisfaction and quantity profile is disclosed. The crossing network includes a number of trader terminals that can be used for entering orders. The orders are entered in the form of a satisfaction density profile that represents a degree of satisfaction to trade a particular instrument at various (price, quantity) combinations. Typically, each order is either a buy order or a sell order. The trader terminals are coupled to a matching controller computer. The matching controller computer can receive as input the satisfaction density profiles entered at each one of the trading terminals. The matching controller computer matches orders (as represented by each trader's satisfaction density profile) so that each trader is assured that the overall outcome of the process (in terms of average price and size of fill) has maximized the mutual satisfaction of all traders. Typically, the matching process is anonymous. The matching process can be continuous or a batch process, or a hybrid of the two. Unmatched satisfaction density profiles can be used to provide spread and pricing information. Factors other than price and quantity also may be used to determine the degree of satisfaction.

In U.S. Pat. No. 6,014,643 to Minton a first individual enters an offer to sell a security on a first data processing system. This offer is sent to a server over a communication network which is available to the public. From the server, the offer is transmitted to additional data processing systems which are connected to the publicly-available communication network. The first user's offer is eventually sent to a second data processing system, where a second individual enters an acceptance to the first user's offer to sell a security. This second user's acceptance is then transmitted back to the server over the publicly-available communication network. Upon the arrival of the acceptance, an account belonging to the second user is debited for the amount of the security just purchased, and the second user obtains title to the securities.

U.S. Pat. No.6,035,287 to Stallaert et al. allows market participants to exchange bundles of assets, including assets in different asset classes. A market participant may value the bundle as an entity, alleviating the need to attempt to attain a value objective in the aggregate by valuing and trading assets individually. A bundle of assets to be traded is entered, wherein proportions of each asset to be traded in units of a specified bundle size are provided by the market participant. Assets to be acquired by one market participant are matched against the same asset which other market participants are seeking to dispose. An exchange of bundled assets among market participants, in units of the bundles themselves is effected when the exchange satisfies a predetermined set of criteria.

In U.S. Pat. No. 6,098,051 to Lupien et al. crossing network that matches buy and sell orders based upon a satisfaction and quantity profile is disclosed. The crossing network includes a number of trader terminals that can be used for entering order. The orders are entered in the form of a satisfaction density profile that represents a degree of satisfaction to trade a particular instrument at various (price, quantity) combinations. Typically, each order is either a buy order or a sell order. The trader terminals are coupled to a matching controller computer. The matching controller computer can receive as input the satisfaction density profiles entered at each one of the trading terminals. The matching controller computer matches orders (as represented by each trader's satisfaction density profile) so that each trader is assured that the overall outcome of the process (in terms of average price and size of fill) has maximized the mutual satisfaction of all traders. Typically, the matching process is anonymous. The matching process can be continuous or a batch process, or a hybrid of the two. Unmatched satisfaction density profiles can be used to provide spread and pricing information. Factors other than price and quantity also may be used to determine the degree of satisfaction. Optionally, priority may be given to certain profiles in the matching process to accommodate stock exchange rules, for example, requiring that priority be given to orders exhibiting the best price, regardless of size or any other consideration. The crossing network has utility both in the securities industry and for non-securities industry applications.

U.S. Pat. No. 6,131,087 to Luke et al. provides a computer implemented method for market participants for automatically identifying and matching offer data with solicitation data, the solicitation data stored in a solicitations data base, the method comprising the steps of: receiving offer data consisting of numerical linear ranges defining a lower point, an upper point, and a preferred point for each dimension of the offer data storing the received offer data in a database; comparing points for each dimension of the stored offer data to corresponding dimensions of the solicitation data to: identify solicitations with matching preferred points, identify solicitations with preferred points having a near match with the offer data when the upper point and the preferred point of the offer data are between the upper point and the preferred point of the solicitation data, and identify solicitations with preferred points within corresponding ranges to the offer data when at least one of the lower point, the upper point, and the preferred point of the offer data is between the lower point and the upper point of the solicitation data; transmitting the identified solicitations with matching preferred points, near matching preferred points, and preferred points within corresponding ranges to originator of the offer data.

In U.S. Pat. No. 6,195,647 to Martyn et al. a data processing system is disclosed which provides an interface with a securities exchange system over which securities are traded. The system allows a user to configure displays tailored for specific functions and to show displays for a particular security. The user may also view a display showing information about selected securities, monitor trade activity, participate in a trade, and report trades. In addition, a user may display information for a selected set of securities on a continuously updated basis and can easily select from a displayed list, a desired security and certain information and functions associated with the selected security.

U.S. Pat. No. 6,272,474 to Garcia provides a method for providing stock information to traders. Stock information is received that includes bid offers, ask offers, the size of the bid offers and the size of the ask offers and the identity of the market makers making each offer. In addition, trade information is received that includes the volume of each trade, the time of each trade, and the price of each trade. The stock information and trade information are displayed on a display screen. The display screen includes a display of bid/ask trade bars for a stock or each of selected number of stocks in which percentage of sales at bid prices and percentage of sales at ask prices are depicted. By considering the display screen, traders are better able to determine trading patterns of the market makers in those selected stocks and increase their probability of buying low and selling high. In a preferred embodiment, the bid/ask trade bars include the following information: the percentage of trades at the ask prices, the percentage of trades at the bid prices, the percentage of trades between the ask and the bid, the bid-to-ask ratio, the volume of trades over a given interval. In a preferred embodiment, the bid/ask bar information can be filtered to represent the trading activity of all of the agents or a specified group of market makers or ECNs. Also, in a preferred embodiment, the stock information and trade information are received at a web site, and the traders who view the display screen are online traders having access to the Internet.

U.S. Pat. No. 6,278,982 to Korhammer et al. provides a securities trading consolidation system where each customer uses a single trader terminal to view, and analyze security market information from and to conduct security transactions with two or more ECNs, or other comparable ATSs, alone or in combination with one or more electronic exchanges. A consolidating computer system supplies the market information and processes the transactions. The consolidating computer system aggregates order book information from each participating ECN order book computer including security, order identification, and bid/ask prices information. Bid and ask prices for participating electronic exchanges may be integrated into the display. The combined information is displayed to a customer by security and by bids and offers, and then sorted by price, volume and other available attributes as desired by the customer. The consolidating computer system forwards to each trading terminal information from only those market maker ECNs and electronic exchanges that the customer is an ECN member or electronic exchange user and thus entitled to receive.

U.S. Pat. No. 6,282,521 to Howorka provides that for each quote entered into a computerized anonymous trading system, the system determines if it is waiting to be “hit” (would be matched with the first hit of a predetermined size) at a substantial number of trading floors, and if so, notifies the trader originating the quote. The substantial number of floors is preferably expressed as greater than a predetermined percentage of the available trading partners with whom credit has been established on a bilateral basis, and is preferably greater than 25%. In an alternate embodiment, the system provides a graphical display to the market maker originating a particular quote indicating how many trading floors are poised to hit that particular quote, and/or a numeric display indicating a price that would be Hittable by a predetermined number or percentage of available trading partners.

U.S. Pat. No. 6,408,282 to Buist provides a system and method that supports trading of securities over the Internet both on national exchanges and outside the national exchanges. The preferred embodiment supports an improved human interface and a continuous display of real-time stock quotes on the user's computer screen. The ergonomic graphical user interface (GUI) of the preferred embodiment includes several functional benefits in comparison with existing on-line consumer trading systems. In the preferred embodiment, the users are subscribers to a securities trading service offered over the Internet. Preferably, each subscriber to this service is simultaneously connected from his own computer to a first system which provides user-to-user trading capabilities and to a second system which is a broker/dealer system of his/her choice. The system providing the user-to-user trading services preferably includes a root server and a hierarchical network of replicated servers supporting replicated databases. The user-to-user system provides real-time continuously updated stock information and facilitates user-to-user trades that have been approved by the broker/dealer systems with which it interacts. Users of the preferred system can trade securities with other users of the system. As part of this user-to-user trading, a user can accept a buy or sell offer at the terms offered or he can initiate a counteroffer and negotiate a trade.

### SUMMARY OF THE INVENTION

The subject invention specifically contemplates a system and method for displaying on a graphical user interface at least one of stock and other equity type information for trade related actions by a user with an electronic exchange, said displaying being configurable by said user, comprising graphically displaying and updating in substantially real time in a first portion of said graphical user interface historical filled order data; graphically displaying and updating in substantially real time in a second portion of said graphical user interface current unfilled order data; graphically displaying said trade related actions made on said graphical user interface by said user; graphically displaying modifications made on said graphical user interface to said trade related actions by said user; and allowing variation by said user of physical dimension of at least one of said first portion and said second portion of said graphical user interface. Depth price bands graphically display the real time depth of the market i.e. the available volume at a particular price. Historical depth of market snapshots, including periodic snapshots, simple average snapshots, weighted average and Max-Min-Open-Close snapshots, can be graphically shown along with real time market data.

Preferably, the trade related actions of the above invention are selected from the group consisting of placing a new order, replacing said new order with a second order, canceling said new order, and canceling a replaced order.

Preferably, modifications to said trade related actions of the above invention is selected from the group consisting of replacing a new order, canceling a new order, and canceling a replaced order.

Preferably, historical filled order data of the above invention is selected from the group consisting of bid, ask and last prices.

Preferably, unfilled order of the above invention is selected from the group consisting of current, bid and ask prices.

Preferably, said variation of said physical dimension of the above invention is selected from the group consisting of x-axis variation and y-axis variation.

### BRIEF DESCRIPTION OF THE DRAWINGS

These and other subjects, features and advantages of the present invention will become more apparent in light of the following detailed description of a best mode embodiment thereof, as illustrated in the accompanying Drawings.

FIG. 1A is a block diagram of hardware elements and software modules of an example of an on-line trading hardware and software infrastructure that can be employed with the subject invention;

FIG. 1B is a computer screen shot of an example of a trade execution management system software that can be employed with the subject invention;

FIG. 1C is a software logic flow chart for the display of real time data of the subject invention;

FIG. 1D is a software logic flow chart for the entry of new order data of the subject invention;

FIG. 1E is a software logic flow chart for the management of orders of the subject invention;

FIG. 2 is a first computer screen shot showing an overview of the graphical user interface of the subject invention;

FIG. 3 is a second computer screen shot showing an overview of the graphical user interface of the subject invention;

FIG. 4 is a third computer screen shot showing an overview of the graphical user interface of the subject invention;

FIG. 5 is a computer screen shot of the multi-scale plotting functionality of the graphical user interface of the subject invention;

FIG. 6 is a first computer screen shot showing the order sending functionality of the graphical user interface of the subject invention;

FIG. 7 is a second computer screen shot showing the order sending functionality of the graphical user interface of the subject invention;

FIG. 8 is a third computer screen shot showing the order sending functionality of the graphical user interface of the subject invention;

FIG. 9 is a fourth computer screen shot showing the order sending functionality of the graphical user interface of the subject invention;

FIG. 10 is a fifth computer screen shot showing the order sending functionality of the graphical user interface of the subject invention;

FIG. 11 is a sixth computer screen shot showing the order sending functionality of the graphical user interface of the subject invention;

FIG. 12 is a computer screen shot showing filled order functionality of the graphical user interface of the subject invention;

FIG. 13 is a computer screen shot showing unfilled order functionality of the graphical user interface of the subject invention;

FIG. 14 is a first computer screen shot showing order placing functionality of the graphical user interface of the subject invention;

FIG. 15 is a second computer screen shot showing order placing functionality of the graphical user interface of the subject invention;

FIG. 16 is a first computer screen shot showing order modification functionality of the graphical user interface of the subject invention;

FIG. 17 is a second computer screen shot showing order modification functionality of the graphical user interface of the subject invention;

FIG. 18 is a third computer screen shot showing order modification functionality of the graphical user interface of the subject invention;

FIG. 19 is a fourth computer screen shot showing order modification functionality of the graphical user interface of the subject invention;

FIG. 20 is a fifth computer screen shot showing order modification functionality of the graphical user interface of the subject invention;

FIG. 21 is a first computer screen shot showing combined plotting functionality of the graphical user interface of the subject invention;

FIG. 22 is a second computer screen shot showing combined plotting functionality of the graphical user interface of the subject invention;

FIG. 23 is a third computer screen shot showing combined plotting functionality of the graphical user interface of the subject invention;

FIG. 24 is a first computer screen shot showing historical depth functionality of the graphical user interface of the subject invention; and

FIG. 25 is a second computer screen shot showing historical depth functionality of the graphical user interface of the subject invention.

### DETAILED DESCRIPTION OF THE PREFERRED EMBODIMENTS

I. On-Line Trading Hardware

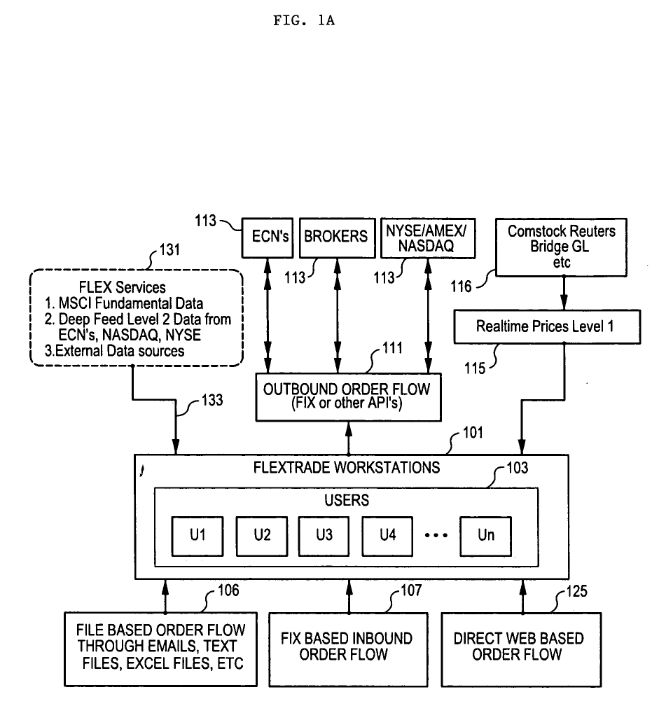

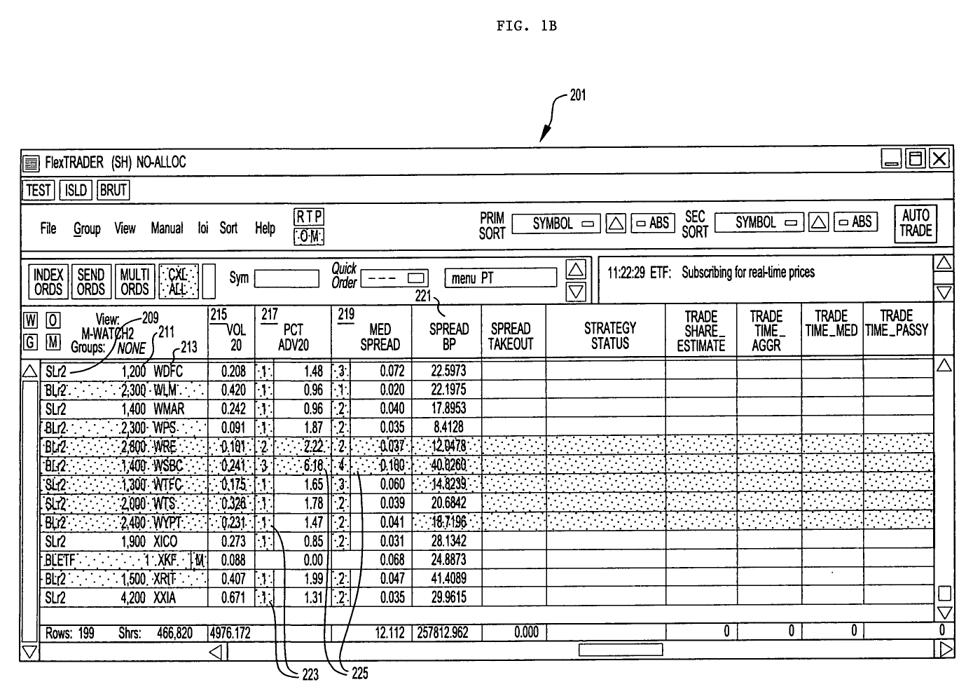

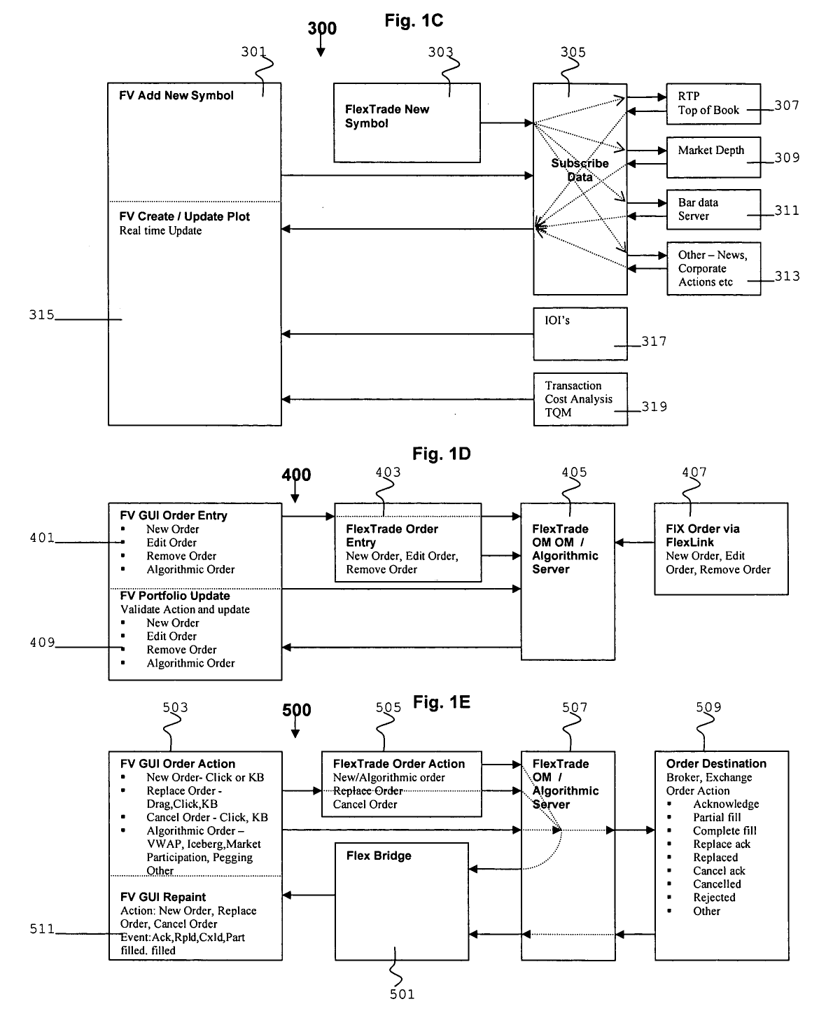

Referring first to FIG. 1A, the hardware elements and software modules of the on-line trading software that can be employed with the subject invention are described. Multiple execution management system work stations 101 are preferably IBM compatible PC computers each having an Intel Pentium-based central processing unit with 512 MB of RAM and a Linux or Microsoft Windows XP operating system. There are preferably multiple user groups 103 running the above workstations, preferably interconnected by a local area network (LAN), with each user group 103 comprised of individual users U₁, U₂ . . . Uₙ. If FlexTrader is the execution management system software program of choice on workstations 101, each of user U₁, U₂ . . . Uₙ can tailor the graphical user interface of the FlexTrader software program to suit their personal preferences. An API (application program interface) communicates with the users U₁, U₂. . . Uₙ of each user group 103 and sends and receives data pertaining to, for example, populating financial data columns or obtaining the results of calculations or the results of actions.

Inbound order flow module 107, operating under the FIX protocol engine, accepts incoming orders described further below. There is network interconnection between inbound order flow module 107 and a software router that is preferably a private network or proprietary network such as TNS (transaction network services) that is a secure high speed connection widely used in the financial industry. Via inbound order flow 107 FIX clients communicate via the TNS network and send FIX-based messages to execution management system workstations 101. Also in electronic communication with inbound order flow module 107 is OMS (order management system) such as, for example, Network Cloud, McGregor, Bloomberg, Brass NYFix, Trade Route, which allows the OMS client to review their portfolios.

Direct web based order flow 125 is in communication, or has connectivity with, execution management system 101, that allows web based order flow 125 to interconnect with the execution management system workstations 101 via front end of the web client.

Order match module 111 includes a FIX-based engine that is in electronic communication with execution management system workstations 101. Order match module 111 is also in electronic communication with other FIX-based trade destinations 113, such as NYSE, and other brokers or ECNs such as Arca, Island, Brut, Instinet, for example. Trade orders are sent from execution management workstations 101 to order match module 111, then to one of the trade destinations 113 where the orders are filled or another trade based action happens, which is then relayed back to order match module 111 with the result being displayed on execution management workstations 101, then continuing to the desired one of the user groups 103 and, finally, to the appropriate one of the users U₁, U₂ . . . Uₙ. API 135 is in communication with order match module 111 and monitors outbound order data.

Next referring to real time pricing module 115, which is a consolidator and data re-formatter of prices from different destinations, real time pricing module 115 communicates to execution management system workstations 101, and specifically to a specific ones of user U1, U2 . . . Un. Data vendors 116, such as Reuters and Comstock, provide real time prices on equities and other types of securities to real time pricing protocol 115.

Flex services module 131 communicates with execution management system workstations 101 via transaction network services 133 (TNS), an example of a viable proprietary data network. Flex services module 131 provides: fundamental data, (Morgan Stanley Country Index) a classification of securities bases on industry and sector level; deep feed level 2 data, the specific information from a price feed similar to real time pricing module 115; and level 1 data, again similar to pricing module 115 data and the basic view of security prices.

File based order input 106 is the input of external trade files (or list of trades to be executed) in, for example, text, Excel or ASCII format, to users U1, U2 . . . Un. File based order input 106 is thus in communication with execution management system workstations 101 in order to facilitate trading.

II. Execution Management System Graphical User Interface

Next referring to FIG. 1B, an example of a graphical user interface is described for an execution management system, in this example FlexTrader, with which the software of the subject invention communicates. First referring to 201 the main screen of the EMS program is shown. The main FlexTrader “blotter” screen 201 is part of the execution management system described in FIG. 1. The “blotter” is configurable to allow the user to perform specific actions. These actions can be unilateral actions or they can be actions on specific rows of the blotter. The actions performed include computation of a certain value, a screen snap shot, or an actual travel action such as “send an order down to the floor,” “correct an order,” “cancel an order” for example.

Spreadsheet 207 of blotter 201 lists portfolio information in rows identified by, for example, portfolio name (SLR2) 209, the number of shares (1,200) 211 and specific symbol (WDFC) 213. Further regarding portfolio name 209, one possible nomenclature denotes SL as “sell long”, SH for “sell short”, BL for “buy long” and BC for “buy cover”, with r2 in all instances being the specific portfolio identifier.

Columns intersect the above described portfolio rows of spread sheet 207, and each column represents a certain characteristics associated with that specific portfolio. In the first column 215, VOL20, is a measurement of that particular portfolio's volatility per stock. Second column 217, PCT ADV20, is the percentage of an equity's shares to trade relative to its average 20 day volume. For example, if over the last 20 days 100,000 shares are traded on the average a day, then 1,200 shares (element 211) is 1.2% of an average day. Third column 219, MED SPREAD, denotes, on the average, the difference between the buying and selling price of the security. Fourth column 221 denotes SPREAD BP, which is calculated by taking that median spread value and dividing it by the stock price. This value is shown in basis points which is 1/1000 (or 0.1 percent) of the median spread. It is to be understood that the above four share characteristics 215-221 are just examples of share characteristics, they are not intended to be all inclusive. Other characteristics include, by not limiting example, the percent change in the stock price from yesterday's close, profit and loss information in either dollars, basis points or cents per share, difficulty to trade factors, and sector or industry grouping (i.e., technology, a biochemical, biotechnology industry group).

Again referring to column 217, PCT ADV20, there are highlighted ranking numbers 223 (i.e., numbers 1, 2 or 3) in the same cell to the left of the actual PCT ADV number. “Ranking” of ranking numbers 223 is broadly defined as a grouping of specific attributes. For example, all the values in second column 217, PCT ADV20, that are above 1 and below 2 fall into rank 1, and all the values that are above 2 and below 4 fall into rank 2.

Next referring to highlighted rows 225 of a plurality of portfolios, highlighted rows 225 are highlighted by left clicking the mouse, holding the left mouse down, and dragging across the desired number of rows. Alternatively, a computer keyboard button tied to a specific portfolio or to a predetermined characteristic of some portfolios can highlight specific portfolio rows. Next, the highlighted rows 225 can be acted upon by the execution management system software by implementation by the user of one or more of command lines 205 to invoke the computation action associated therewith. The result, in one possibility, being the population or re-population of ranking numbers 223.

III. Graphical User Interface Software

The software logic of the subject invention, in a non-limiting example, is next described as shown in FIGS. 1C, 1D and 1E.

A. Real Time Data Display

First referring to FIG. 1C, the software logic for display of real time data is described. The subject invention displays real time historical bar data; and can also plot various types of data, both real time and historic. The types of data that are displayable with the subject invention by non-limiting example, include market data, market depth, analytics, IOI's (indication of interest), transaction cost analysis, corporate action and news. The above data is obtained by subscription.

More specifically, real time data display software subroutine 300 first allows user entry of a new stock or other equity trading symbol by the user through the graphical user interface of the subject invention at 301. The front end of the execution management system, for example FlexTrader of FIG. 1B, also acquires the aforementioned new stock or equity trading symbol at 303. From blocks 301 and 301 the data pertaining to the new stock or symbol is obtained at subscribe data portal 305 via two way communication with, for example, real time price server 307, market depth server 309, bar data 311 and corporate action and news server 313. Subscribe data portal 305 forwards the data from 307, 309, 311, and 313 to the graphical user interface of the subject invention where the plot or graph is updated for the user in real time at block 315. Also at block 315, the graphical user interface of the subject invention updates the plot or graph for the user in real time based on data for indication of interest calculated at block 317 and for transaction cost analysis and transaction quality management at block 319.

B. New Order Entry

Referring next to FIG. 1D, the software of the subject invention can enter new stock or other equity orders in numerous ways.

First, the order entry graphical user interface 401 of the subject invention (by which the user can place new orders, edit existing orders, remove orders and function on algorithmic orders) can send an order request to the order entry subroutine 403 of the execution management system, for example FlexTrader of FIG. 1B (which can enter new orders, edit existing orders and remove orders). In turn order entry subroutine 403 sends the order to the order management algorithmic server 405 of the execution management system.

Second, the order can be created first using order entry subroutine 403 of the execution management system, which sends the order to order management algorithmic server 405.

Third, the order can be created by using order entry graphical user interface 401 of the subject invention in direct communication with order management algorithmic server 405.

Fourth, an order can be received electronically by the subject invention via the FIX api 407 (which can process new orders, edit orders and remove orders) that passes the order to portfolio update subroutine 409 of the subject invention.

Whenever a new order is created, regardless of which of the above protocols is employed, order management algorithmic server 405 of the execution management system communicates to FlexBridger server (501 of FIG. 1E) which, in turn, passes notification of the order to order entry graphical user interface 401 of the subject invention.

C. Order Management

Referring next to FIG. 1E, the software logic process of order management of the subject invention is shown. Order management functions of various types are performed by different human interface options of order action graphical user interface 503 such as, for example, mouse button click, mouse button press-drag-release or keyboard actions such as pre-programmed or programmable keys (KB). Order actions of order action graphical user interface 503 include new order, replace order, cancel order and algorithmic order, for example.

The software of the subject invention can manage orders in numerous ways.

First, the order action graphical user interface 503 of the subject invention can send an order management request to the order action subroutine 505 of the execution management system, for example FlexTrader of FIG. 1B (which can manage: new orders, the editing of existing orders and the removal of orders). In turn order action subroutine 505 sends the order management information to the order management algorithmic server 507 of the execution management system.

Second, the management of orders can be performed first using order action subroutine 505 of the execution management system, which sends the order management information to order management algorithmic server 507.

Third, the order management information can be created by using order action graphical user interface 503 of the subject invention in direct communication with order management algorithmic server 507.

Employing any of the above three order management protocols, the order management information next is sent by order management algorithmic server 507 to the order destination 509 via a FIX or other api connection. Order destination 509 may be, by non-limiting example, a broker or an exchange that performs order actions that include, by non-limiting example Acknowledge, Partial Fill, Complete Fill, Replace Acknowledge, Replaced, Cancel Acknowledge, Cancelled and Rejected, among others. Next, order destination 509 sends back to order management algorithmic server 507 a FIX communication responsive to the particular order management action request initially received by order destination 509. Finally, this FIX communication passes via FlexBridge 501 to the graphical user interface repaint subroutine 511 that implements the appropriate revisions to the graphical user interface precipitated by the original order management action.

IV. Graphical User Interface Function Overview

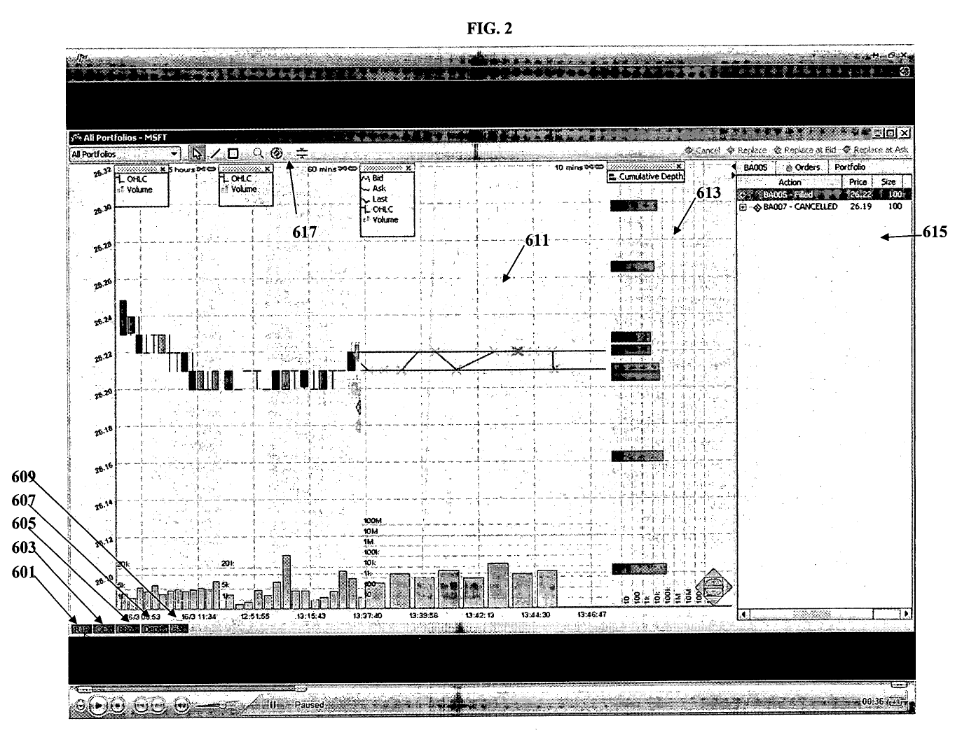

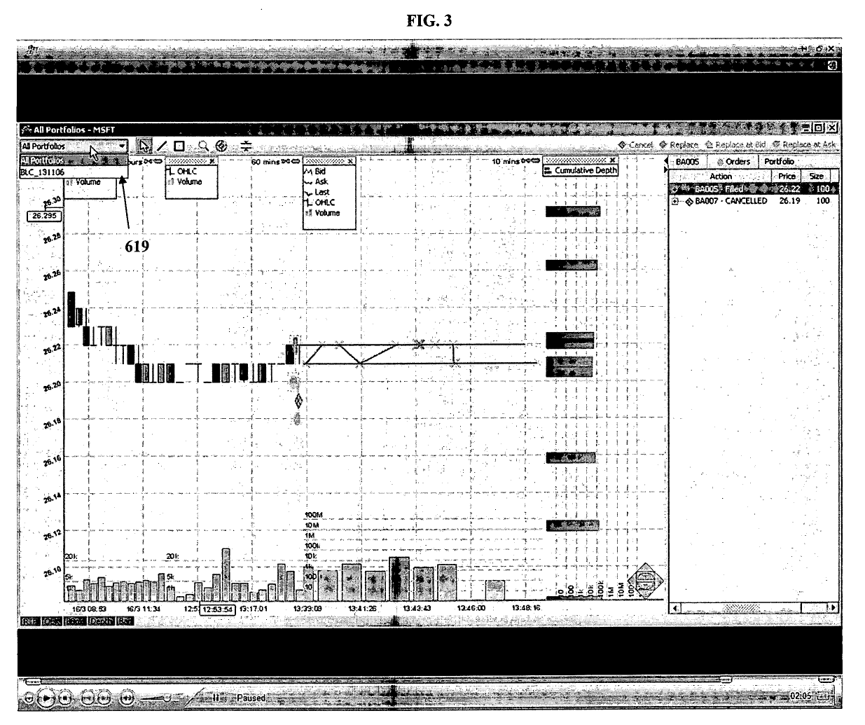

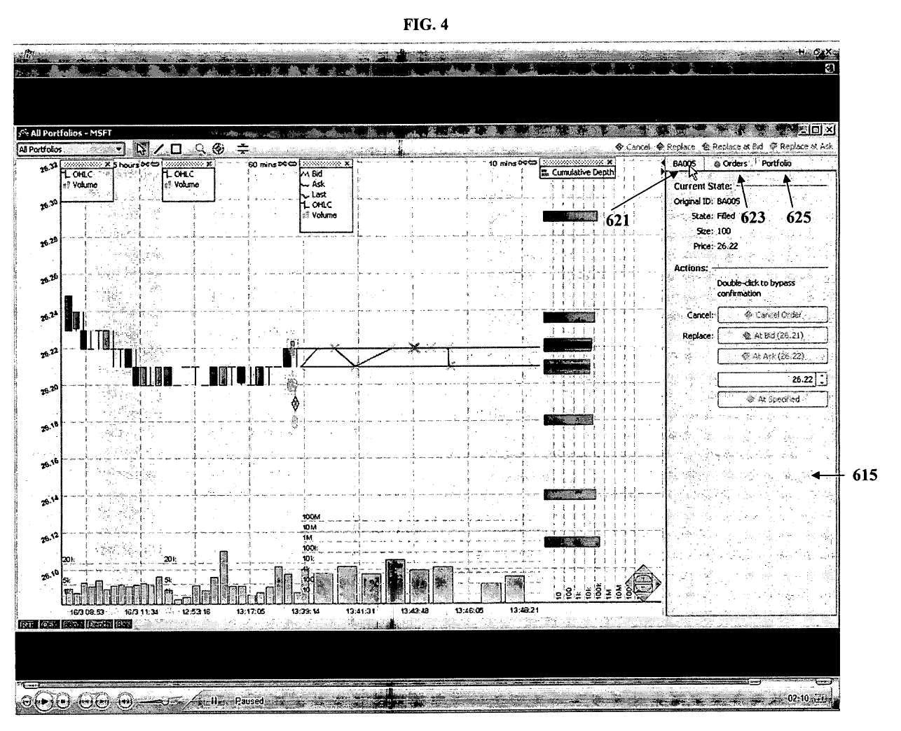

FIG. 2 shows the screen 600 from where the trader can interact with the software application of the subject invention, view market history, and then send orders into the desired trading exchange from on-line trading programs known in the art.

On the bottom of the screen are the different indicators that tell the status of the application. RTP 601 stands for Real Time Price Server, which confirms connection to a centralized market data source with real-time market data to the application. The OEX button 603 shows connection to an order manager and all the order information is available in real-time. B Box 605 stands for “black box” which is the application that actually does orders into the exchange. “Depth” 607 denotes access to the depth of the market, which is also called as level 2. Bar F relates to bar data for the open high, close low plots.

FIG. 2 shows the actual plot where real time market data is being plotted at 611. Also seen is the depth of the market at 613. FIG. 2 shows all the order information, portfolio information, and specifically, order information for orders that have been sent by traders using an on-line trading program at 615.

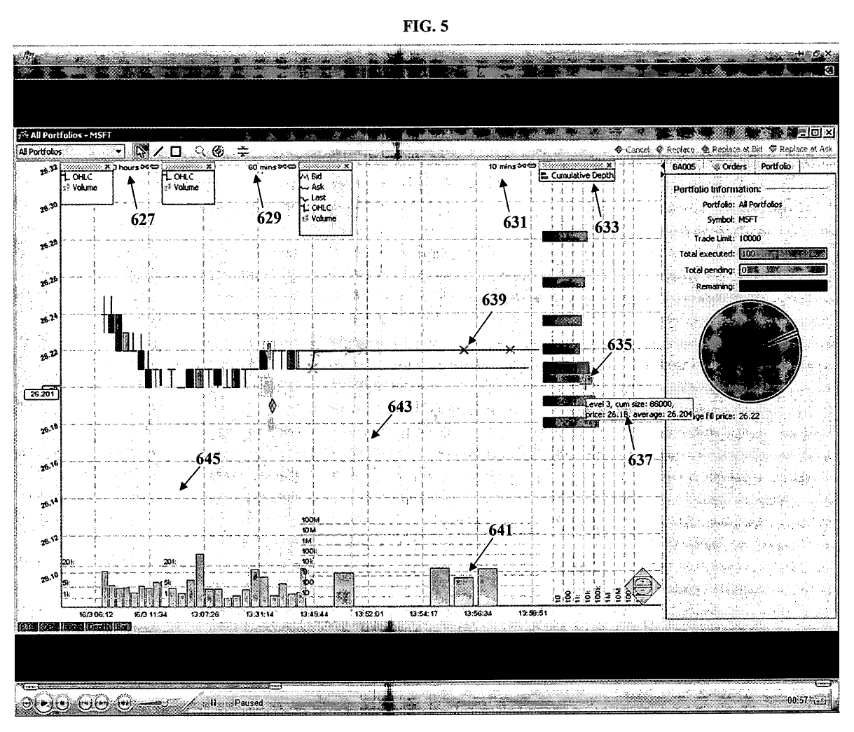

FIG. 2 shows the set of screen buttons that allow interaction with the front end (align, box, zoom, send orders and auto-scale, for example) at 617. FIG. 3 shows a list of portfolios that have been loaded by the trader through which one can send orders into the market at 619. FIG. 4 shows how the trader can interact with the orders at on-line trading program 615 by, for example, mouse clicking portfolio 621, orders 623, and portfolio 625 buttons.

V. Multi-Scale Plot

Next referring to FIG. 5, the multi-scale plots which are available on user front end of the software of the subject invention are next shown. The main plot area is divided into four sections, Section One 627, Section Two 629, Section Three 631 and Section Four 633. Each of these Sections has a different scale and different associated meaning.

The first three 627, 629, 631 sections are plotting the market data history on different scales. The first Section 627 is plotting ten hours worth of data as candlesticks. The second Section 629 shows sixty minutes, which is one hour of data, and the third Section 631 shows ten minutes (which is real-time, every change in “bid,” “ask,” and “last” of the particular stock). Section 633 shows the depth of the market, which is the different sizes and prices available instantaneously at that moment in the market, an example of which for the curser location 635 is shown by data box 637.

A candlestick is a plot which provides for a duration the open high, low and close price of a stock was. A color preferably indicates the relation between the starting price and the ending price. If red, the end price was lower than the start price, if green the end price was higher than the start price. The first two Sections 627 and 629 utilize the candlestick red/green plot and the third Section 631 actually plots every change, in three different colors. The blue is the “ask,” the red is the “bid,” and the green is providing the trade or the last price. The “X” 639 indicates when the trade took place, and the bar 641 on the bottom shows the volume that traded at that price.

The above multi-scale graph allows the user to visually access a vast amount of data while concentrating on different focused sections of current market information. In the first Section 627, one is able to see as much as 200 days worth of data in order to ascertain the patterns the stock has had historically. On the same graph, the trader also can see what is happening to this stock over the day period, as well as real time instantaneous information, and the depth of the market. The above hybrid time-based interface allows the trader to make more informed trade decisions.

Volume profiles are shown which have two scales to allow the trader to see the orders as they trade or the volume for the orders that have traded in different sections. One scale is for real-time at 643 and a second scale is for historical analysis at 645.

VI. Sending Orders

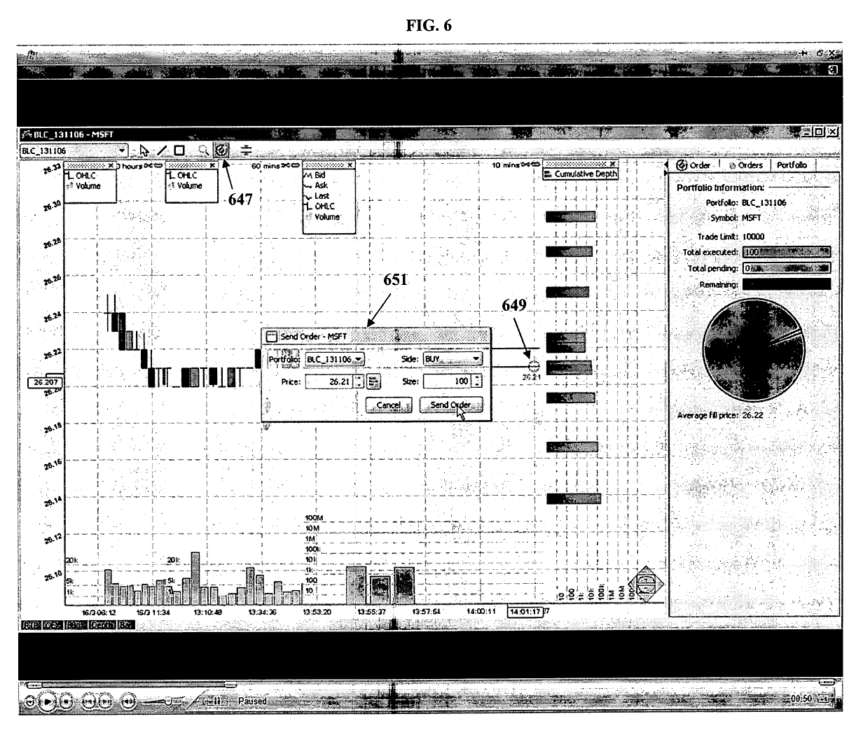

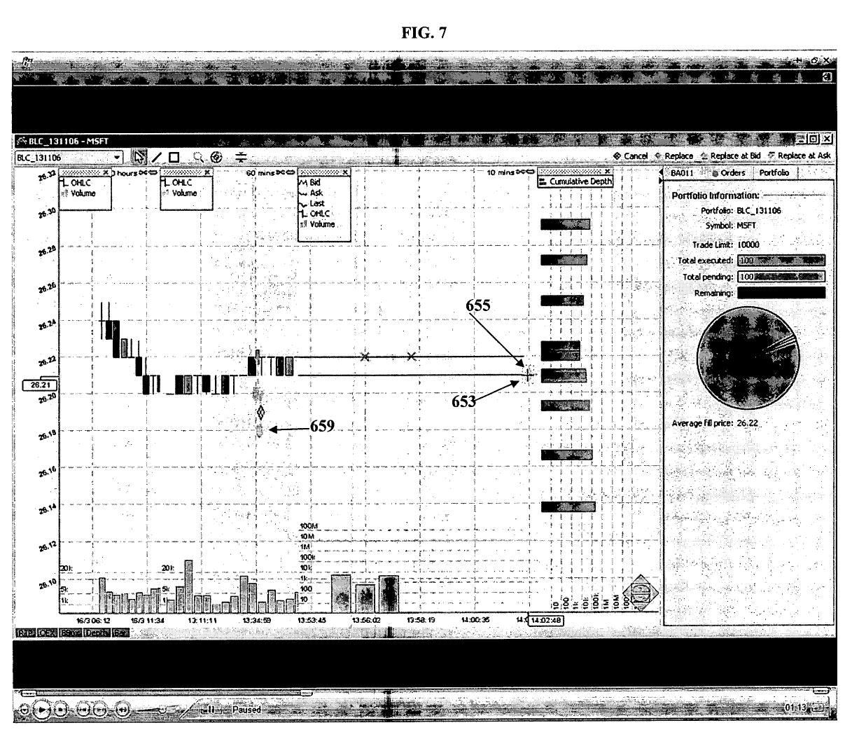

Next discussed are the on-line execution of trades to different brokers or the exchanges employing the subject invention. When the B box of 609 of FIG. 2 is green in color, it indicates connection to the on-line trading application thus showing the capability to send orders in the market. At the top left of FIG. 3, is the list of portfolios from which one can trade the stock. For example, BLT at 619, which is a portfolio, can be traded using the order selecting tool 647 of FIG. 6. Mouse clicking, for example, initiates order sending mode, as shown by the target sign 649 in FIG. 6 which shows at what price one can send the order to the market. Mouse clicking, for example, brings up a send order ticket 651 and one can then “Send Order” by mouse clicking. At this time an order is sent into the desired exchange via an on-line trading program. Again, the price of the order is determined by where the mouse cursor is located, and one can still change the before the order is sent.

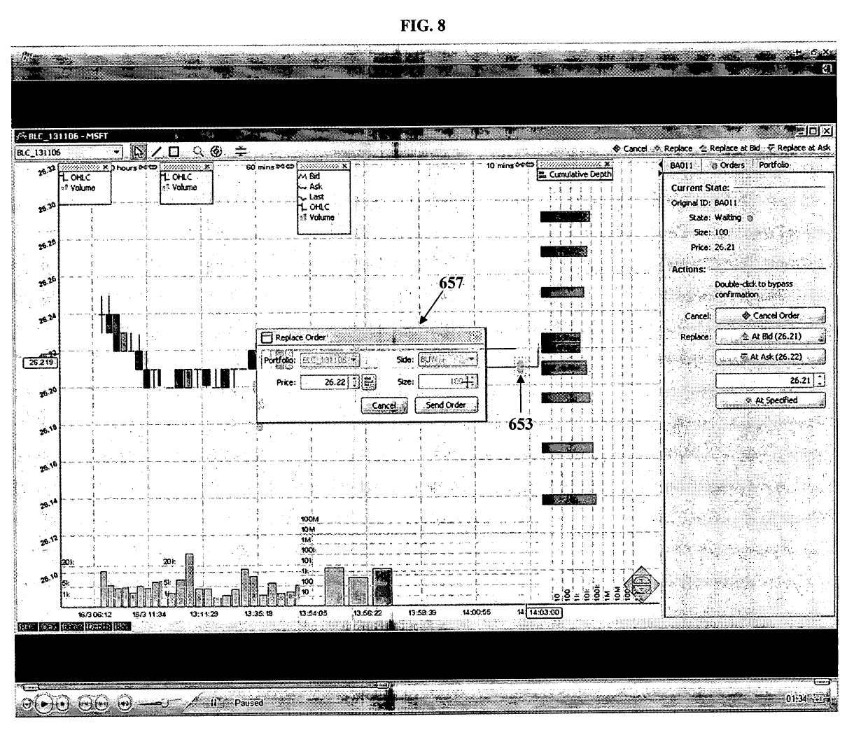

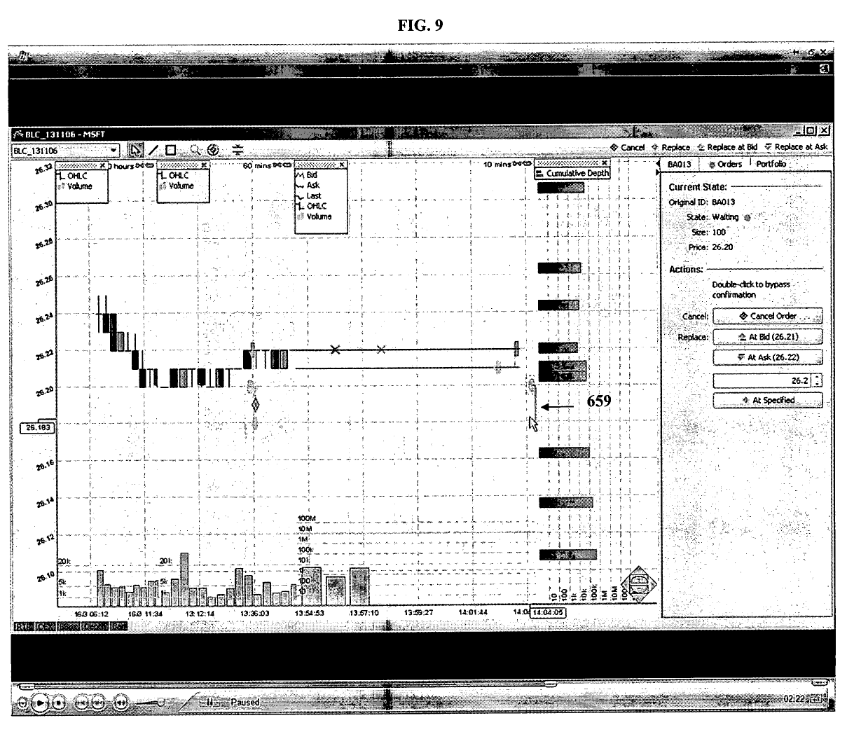

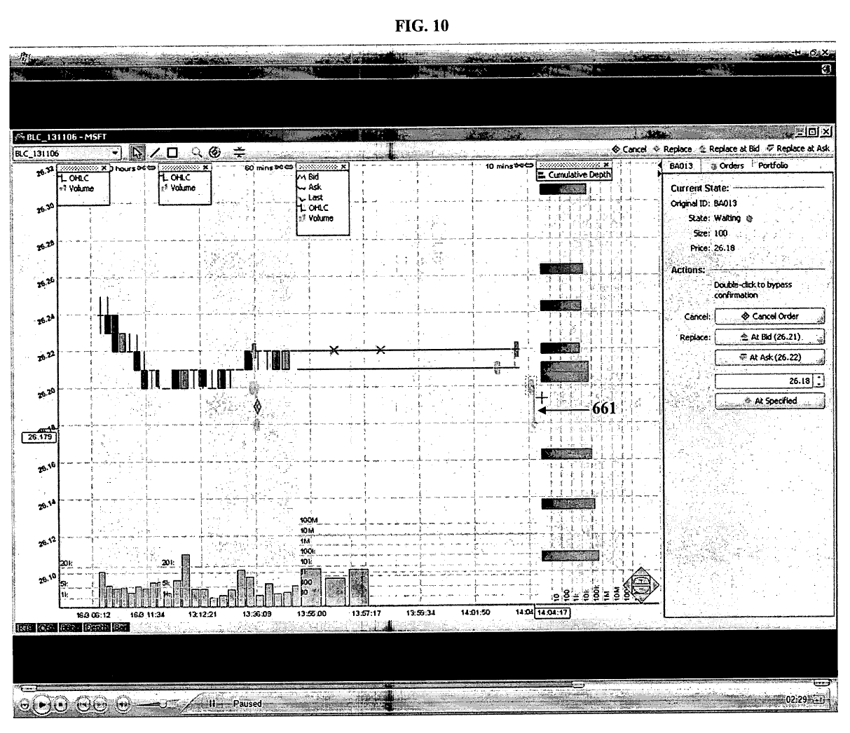

Next referring to FIG. 7, once the order is sent to the desired market, an active order symbol 653 indicates that the particular order is active in the market at this moment. Mouse-clocking on an order adds a visual border 655 around the particular order, and allows one to interact with that particular order, either by the right hand screen icons of the on-line trading program (615 of FIG. 2), or importantly, graphically, through movement of the mouse on the on-screen chart, itself. For example, by mouse-clicking on the order 653 at the desired price point on the screen chart, as shown in FIG. 8, this “Send Order” command invokes a “replace” action 655, or a “modify” action, in the selected exchange, in this example replacing the price of 26.21 with 26.22. Again referring to FIG. 7, there are shown orders that have been altered and plotted at 659; as time moves on, these orders will move leftwards.

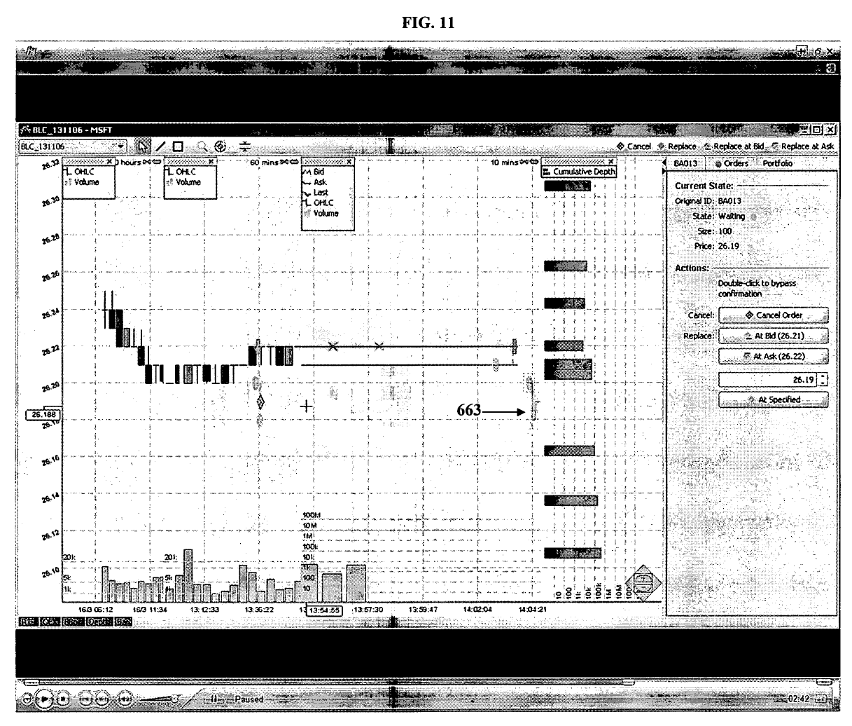

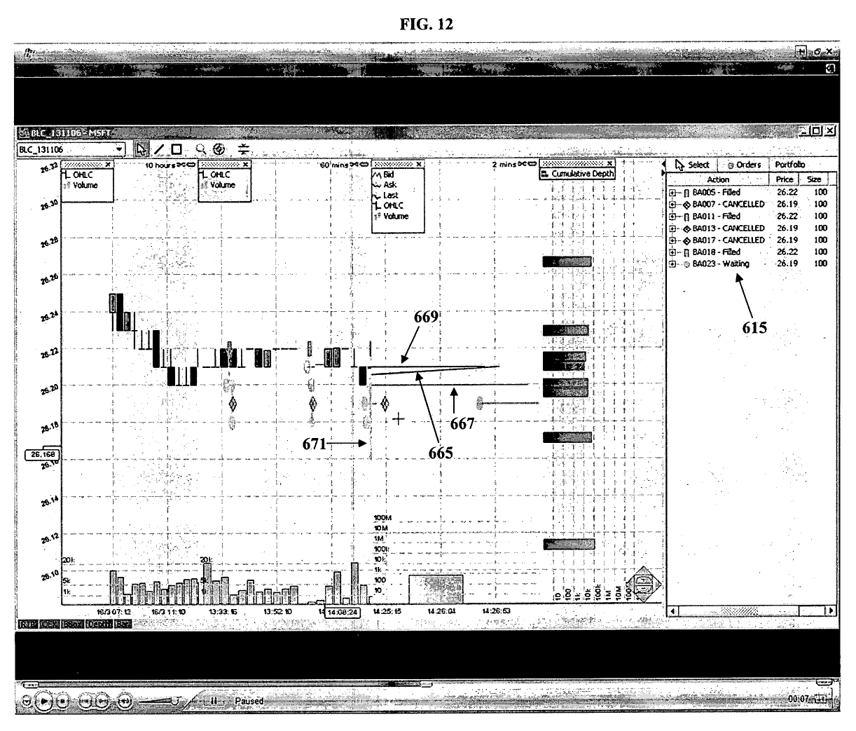

There are different actions that can be made to open orders. As previously shown in FIG. 6, choosing “order selecting tool” 647, invokes a command to send an order to the market. Dragging this selected order with the mouse, as shown in FIG. 9 at 659 replaces the order currently in the market. Mouse-clicking on the order and dragging it to a new price point on the screen sends the next order out as a new order as shown in FIG. 10 at 661. Mouse-clicking on this new order and selecting the “cancel” option will cancel this order as shown in FIG. 11 at 663 and FIG. 8 at 657.

VII. Real Time Data

Next referring to FIG. 12, real-time stock trading data from a central data source is plotted on the on-screen chart with: the green line of 665 showing the “last,” the red line of 667 showing the “bid,” the blue line of 669 showing the “ask” of the stock selected. As new bid prices come in, this line extends in substantially real time to reflect the current “bid” price is, “last” and “ask.” Other variables, such as B-Vap or any other market data source which have been submitted or transmitted by the stock exchange, can also be plotted in substantially real time.

On the left panel of FIG. 12 is the bar data server, which includes the open “high,” “low” and “close” plots of some historic data which has been saved by the bar data server, and connects to the on-line trading application.

VIII. Showing Filled Orders

All of the orders that have been sent and filled are shown connected by the orange line 671 of FIG. 12, which means that these are inactive and that they no longer exist in the market.

IX. Current Unfilled Orders

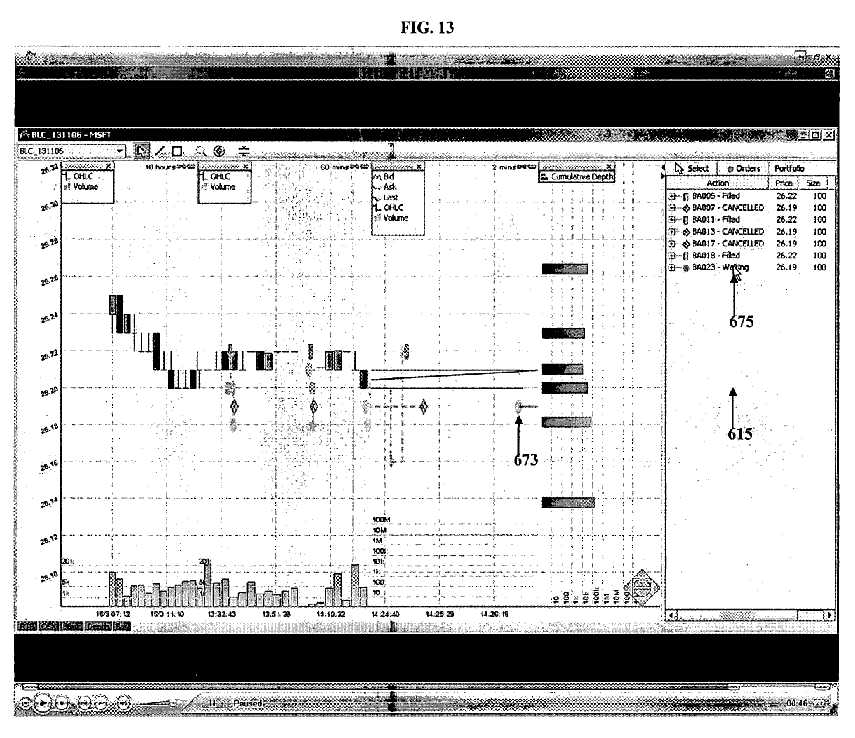

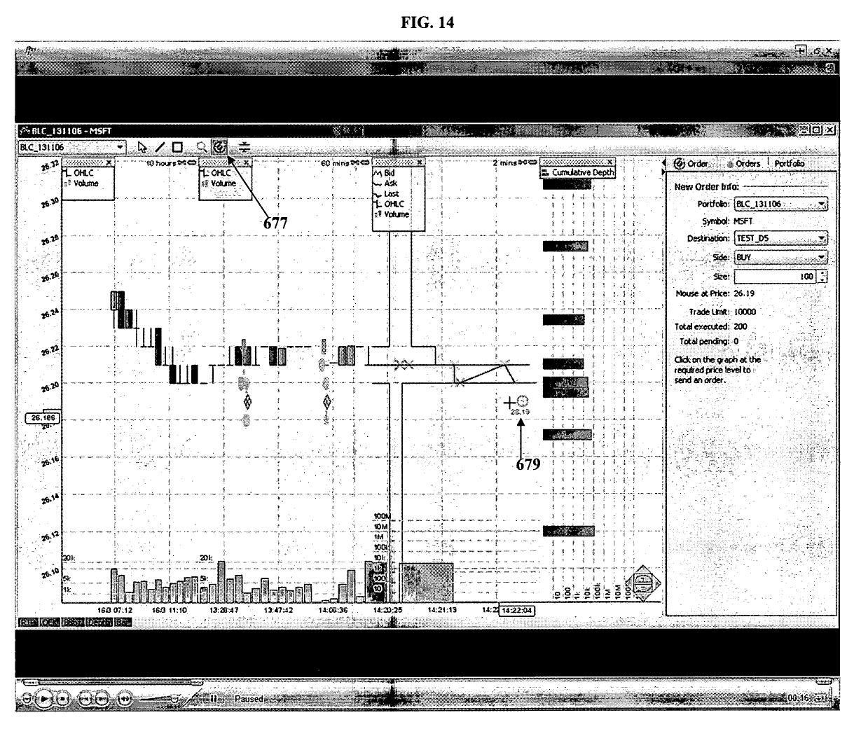

In FIG. 13, the displaying and upgrading of real-time current unfilled orders data in the on-line trading portion 615 of the graph is shown. All the orders that have been sent are currently being displayed, historically: at what price they were placed, at what time they were placed, and what current actions, and what actions took place on those orders in that time (i.e. if they were filled, if they were open). Historically, thirty days worth of data can be loaded.

An order can be mouse-clicked to be activated and sent as discussed in reference to FIG. 6 above, and this active order is now visible at 673 of FIG. 13. This order can stay open as long as desired, with the order line shown extending in time on the screen. On the right hand on-line trading portion 615 is shown which orders have been filled, cancelled, or waiting; and waiting are also fillable graphically on the main screen by mouse action. Waiting order 673 is shown in on-line trading portion 615 at 675.

X. Placing an Order

Next referring to FIG. 14, placing a trade order by interacting with the on-screen graphical interface can be by point-and-click.

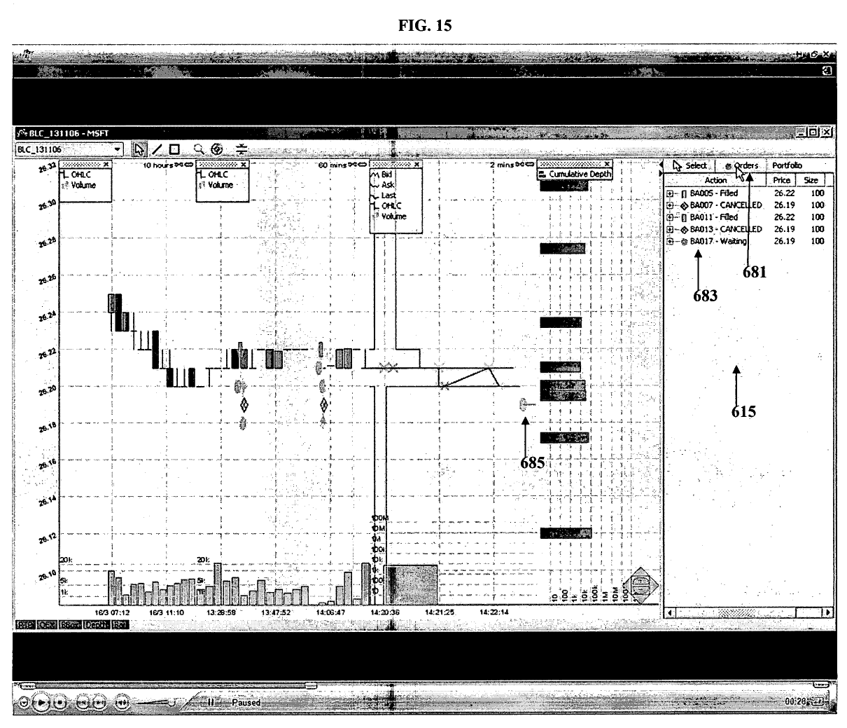

First, the order sending tool 677 is accessed by mouse, which activates the order sending capabilities. What price the order will be placed based on the mouse position on the screen when clicked is shown at 679. Mouse clicking brings up the send alert ticket of (651 of FIG. 6). By mouse-clicking “Send Order;” the order price was determined by where the mouse was placed on the screen when the user clicked on the mouse. As soon as this is done, an order is sent to the market, as shown at Orders tab 681 of on-line trading portion 615 of FIG. 15, where the order BA017 has been sent to the market, has been acknowledged by the market, and is waiting for execution in the market at 683. One can next select this order and take different actions on it, as further discussed in VIII below.

There is no limit to how many orders one can place and have open in the market. Each one of them will be represented by an oval and a line joining it to the current time axis as shown at 685 of FIG. 15. As time moves along, these orders will be shown both at the time point they were placed and at the current time point.

XI. Making Modifications to Orders

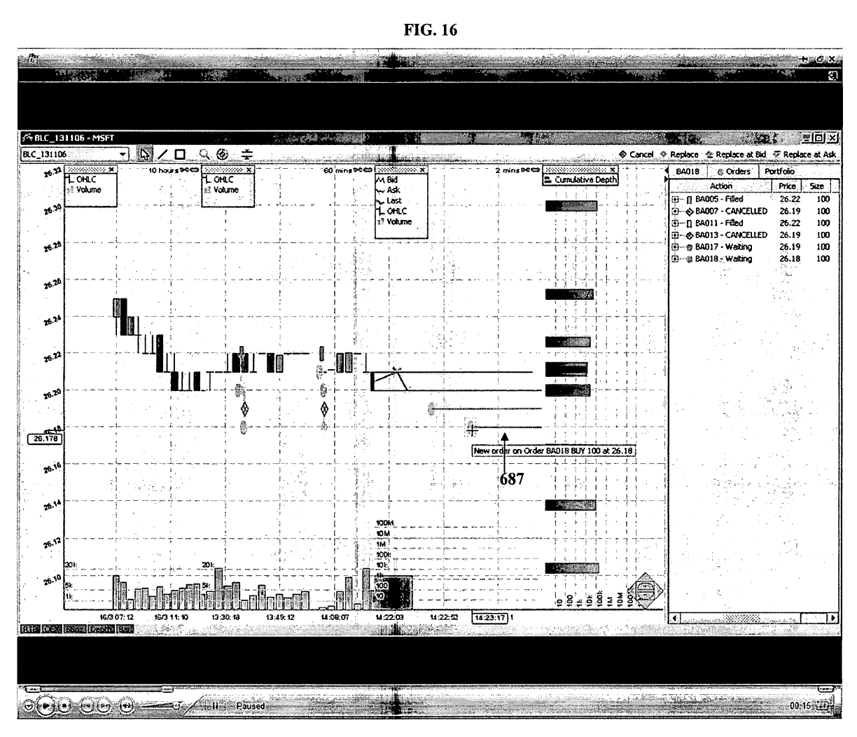

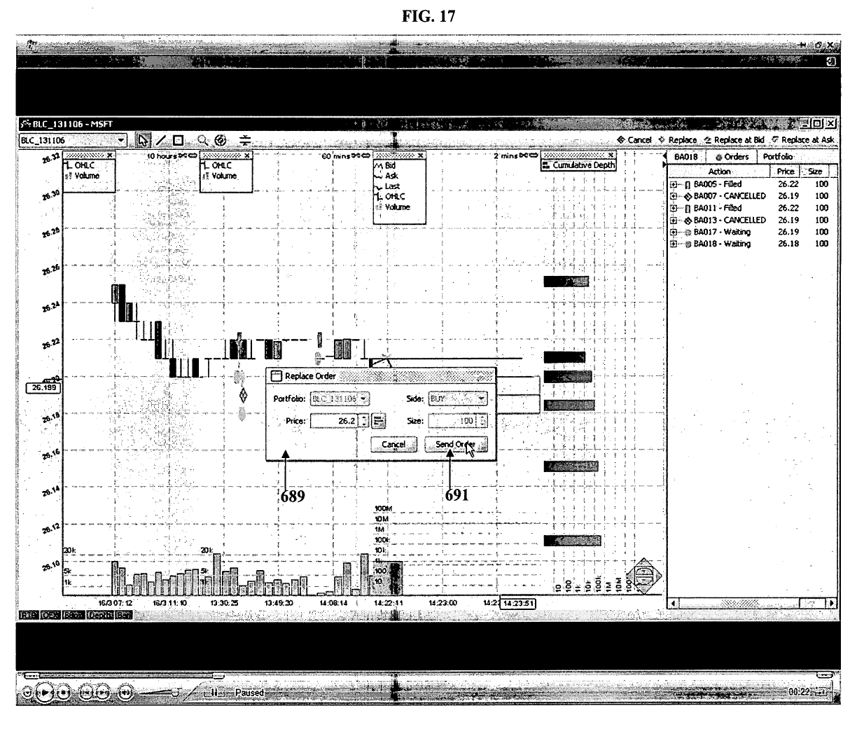

FIG. 16 shows the making of modifications to open trade orders by interacting with the on-screen graph, including fee placing and hold canceling. Moving the mouse, with mouse button depressed, along the open trade order line 687 shows the new price at which one can sell this order or replace this order. Releasing the mouse button actuates the “Replace Order” ticket 689 of FIG. 17, which notifies at what price the original order price is going to be replaced. As soon as one mouse-clicks “Send Order” 691, the system replaces the order price.

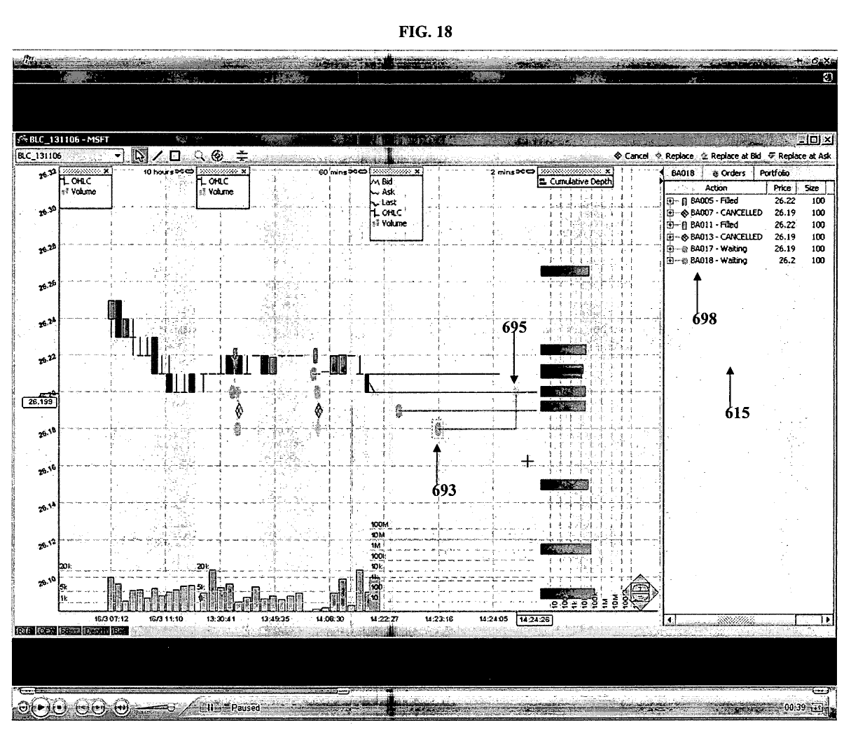

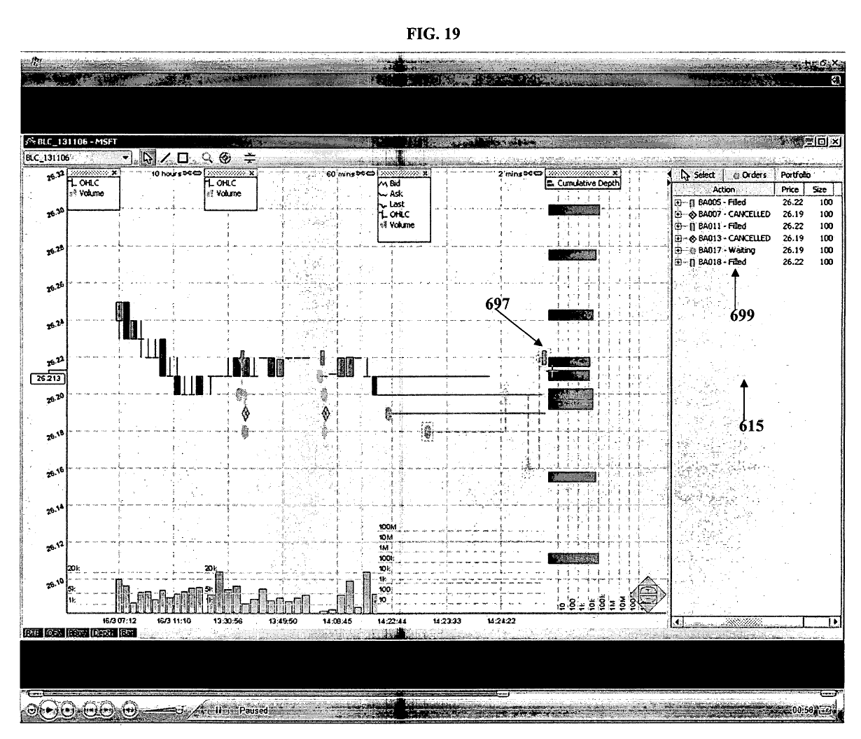

There is no limit to how many times one can modify an open order. As shown in FIG. 18, the price of FIG. 17 at 693 of FIG. 18 is replaced with a new price at 695. FIG. 19 shows modification to an even higher price at 697; as soon as the trade is executed a green rectangle indicates that the open order is now a filled order. The right hand on-line trading portion 615 in FIG. 19 shows that this order BA018 has been changed to “filled” at 699 from “waiting” at 698 of FIG. 18.

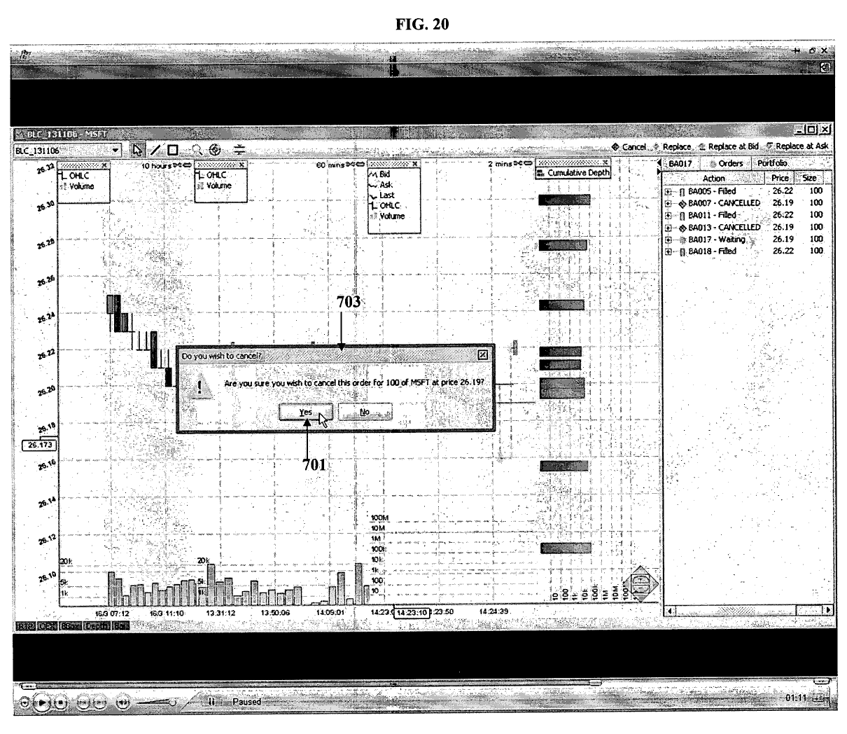

As shown in FIG. 20 returning to a previous open order, highlighting it, clicking on the “Yes” button 701 of the cancellation confirmation window 701, allows the cancellation of this order, which sends a cancel request to the exchange via the on-line trading software. The color of the line associated with the orders changes as soon as the order is inactive to indicate that one can not take any further action on these orders any.

XII. Combined Plot

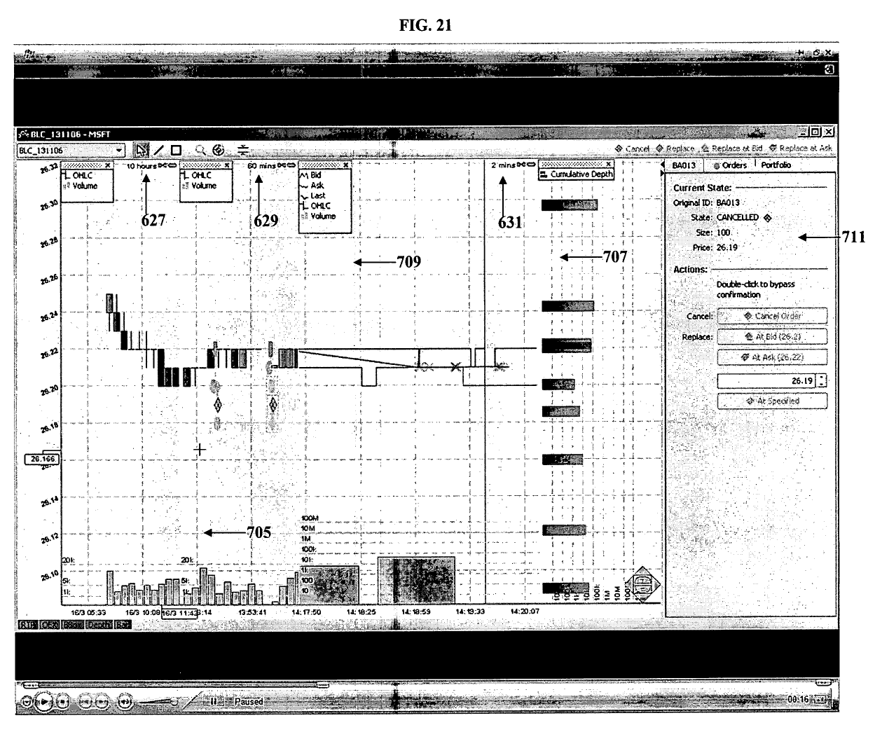

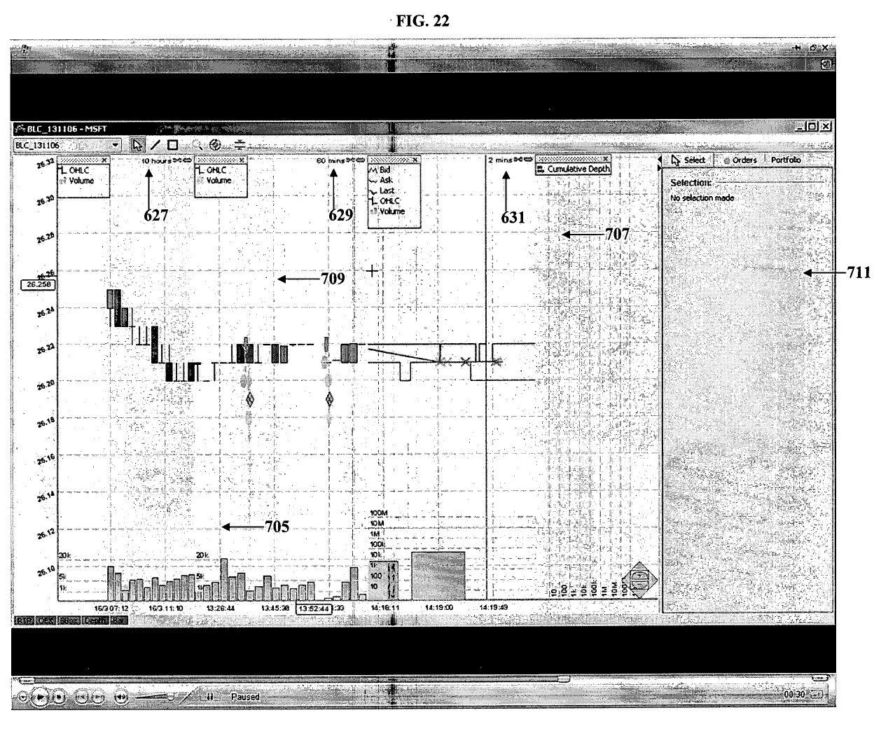

FIGS. 21 through 23 show four combined graphical format positions: vertical bar graph 705, depth of market 707, x y horizontal linear graphs 709 and market price combined format 711.

Market data provides depth of the market. In the market data section also shown are historically all the orders that have been placed and modified visible for the rest of the trading day. Historical orders, which are orders done in the past thirty days, are also plottable. All of this historical data is saved in a database known in the art and accessed for graphical presentation.

XIII. Variable Sizing

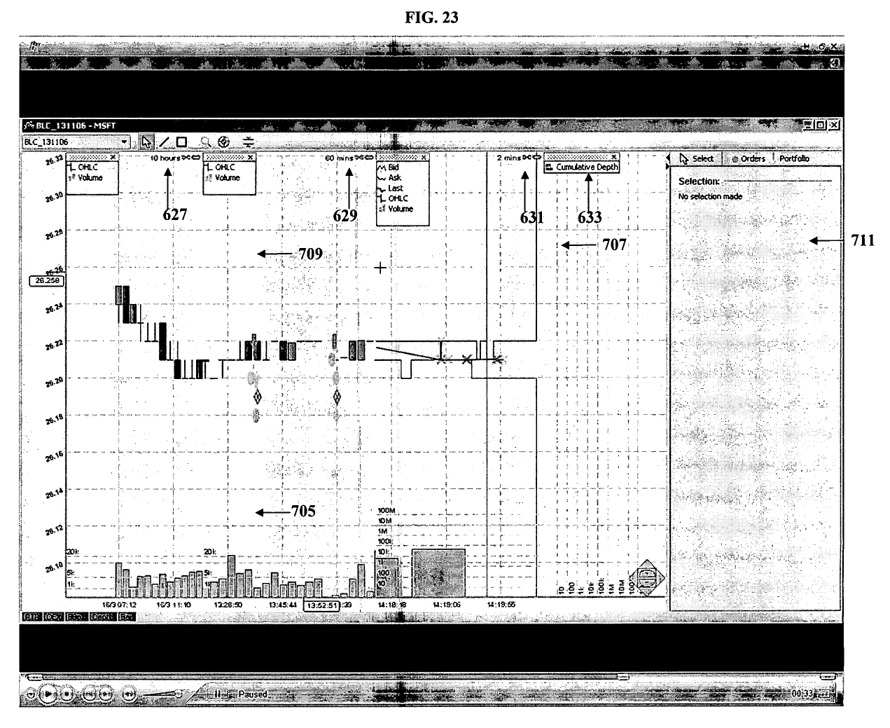

Variable sizing of the time domain of the multi-scale plots (Section One 627, Section Two 629 and Section Three 631 of Part V above and FIG. 5) is accomplished by dragging the time axis horizontally with a depressed button of the mouse. As shown in comparison of FIG. 21, FIG. 22 and FIG. 23, the relative sizes of the three available time domains 627, 629 and 631 have been altered in this manner to illustrate some of the potentially infinite time domain axis size variations, and resulting data re-sizing and re-scaling, available.

XIV. Depth Price Bands

The depth of market for any stock is the volume available at the different prices. For some users the price is not as relevant as price bands denoting this depth of market. Price bands show the user available volume at a particular price, i.e. the depth of market, so that the user can make quick decisions on the market impact they are willing to accept.

In the subject invention there are N levels of depth of market available, at price DPi, Volume DVi, where i=1, 2 . . . N. The user can choose to see bands at intervals of B (bps), or C (cents) with the stock having a price P. To compute the bands we have:

| Variable | Meaning | Units | Possible Values |
|---|---|---|---|
| N | No. of depth levels | None | |
| DPi | Price at level I | $/share | |
| DVi | Volume at level I | Shares | |
| I | Counter | None | 1, 2, . . . N |
| B | Basis Points | None | |
| C | Cents/share | $/Share | |
| J | Band number | None | |
| P | Price of stock | $/share | |
| Sj | Slippage at J | $/share | = C * J = B * P * J |

```
Avg Price = 0
Total Vol = 0
I = 0
Flag = 0
Sj = B*J*P, or C*J
while(flag = 0 AND I < max depth levels)
{
    if(Avg Price = 0)
    {
        if(DPi − P < Sj)
        {
            Max Vol = DVi
        }
        else
        {
            Max Vol = 0
            Flag = 1
        }
    }
    else
    {
        Max Vol = Total Vol * [(P + Sj − Avg Price) / (DPi − (P + Sj))]
        If(Max Vol >= DVi)
        {
            Max Vol = DVi
            Flag = 1
        }
    Avg Price = (Avg Price * Total Vol + DPi * Max Vol) / (Total
    Vol + Max Vol)
    Total Vol += Max Vol
    }
    I++
}
```

The above is computer pseudo-code easily converted into one or more suitable computer software languages including, for example: BASIC programming language, C/C++, Cobol, F, Fortran, Lua, Pascal, PL/I, RPG, or Perl.

XV. Historical Depth Snapshot

The ability to plot the historical depth of the market, as defined in XIV above, with average snapshots graphically displayed on periodic intervals, is referred to as the Historical Depth Snapshot and allows a user to view historically the trends of the market, preferably in conjunction with other, real time market data displays. The different historical depth options to plot, along with real time data, are snapshots of the depth at a given period; of average depth for the interval (average depth can be either the Simple Average of available sizes at periodic sub-intervals or the Weighted Average whereby the duration for which the size is available is factored in the average); or of Max-Min-Open-Close as candle stick objects for each period.

For the Average Volume Vx for X bands, x=1, 2, . . . X., a snapshot is taken every S seconds. A subinterval of nS seconds is used for averaging (M=S/nS). Depth price is DPi, and Volume is DVi at Depth I, I=1, 2, 3 . . . N:

| Variable | Meaning | Units | Possible Values |
|---|---|---|---|
| N | No. of depth levels | None | |
| DPi | Price at level I | $/share | |
| DVi | Volume at level I | Shares | |
| I | Counter | None | 1, 2, . . . N |
| X | Number of bands | None | |
| Vx | Volume at Band x | Shares | |
| Px | Price at Band x | $/share | |
| M | Number of sub-intervals | None | = S/nS |
| S | Period for 1 interval | Seconds | |
| nS | Period of sub-interval | Seconds | |
| T | Current Time | Seconds | |
| Tx | Time of last Tick at Price Px | Seconds | |

For a Periodic snapshot plot, a snapshot is taken every S seconds with the snapshot of the depth being Vx=DVi, I=1, 2, . . . X.

For a Simple Average snapshot plot, the snapshot is taken every nS seconds where Interval=I, I=1, 2, . . . M. To update the snap shot, Vx=Vx+DVx, x=1, 2, . . . X and every S seconds, Vx=Vx/M.

For a Weighted Average plotting, calculate the time intervals for which the volume is available Tx (time when last Volume change took place). Every change in Depth Volume at Price Px is calculated as Vx=Vx+DVi(prev)*(T−Tx), Tx=T. At the end of interval calculate: Vx=Vx/S, X=1, 2, . . . X, Tx=T.

Max-Min-Open-Close plotting displays an indicator of volume available during that time interval. For every S seconds, record the volume of close for previous interval, record the volume available at open time, and reset Max=0 and Min to infinite. At each depth change check and update the maximum and minimum for Vx.

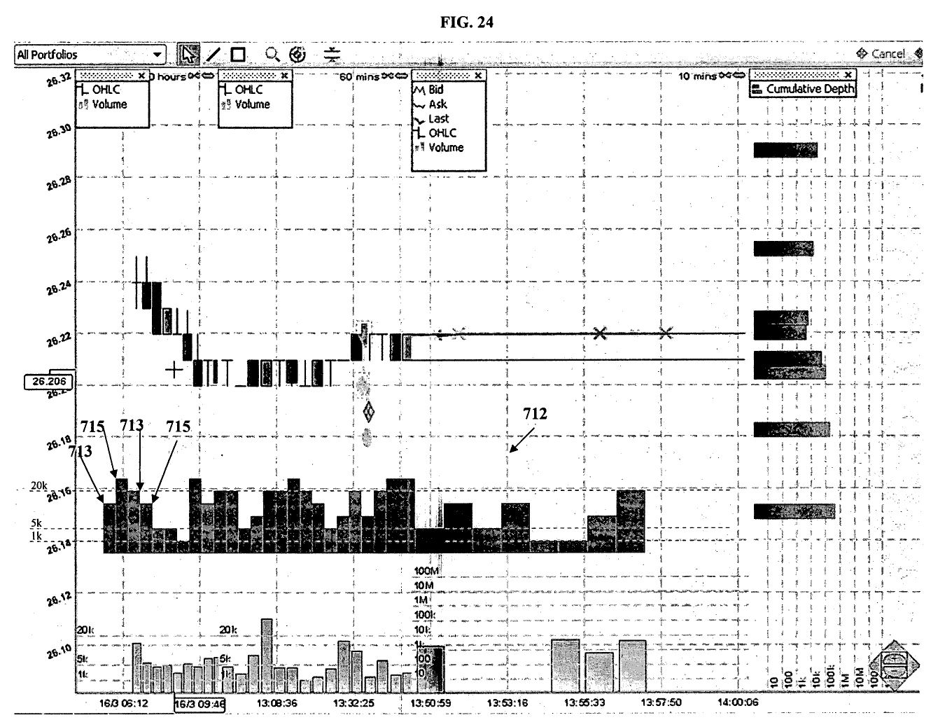

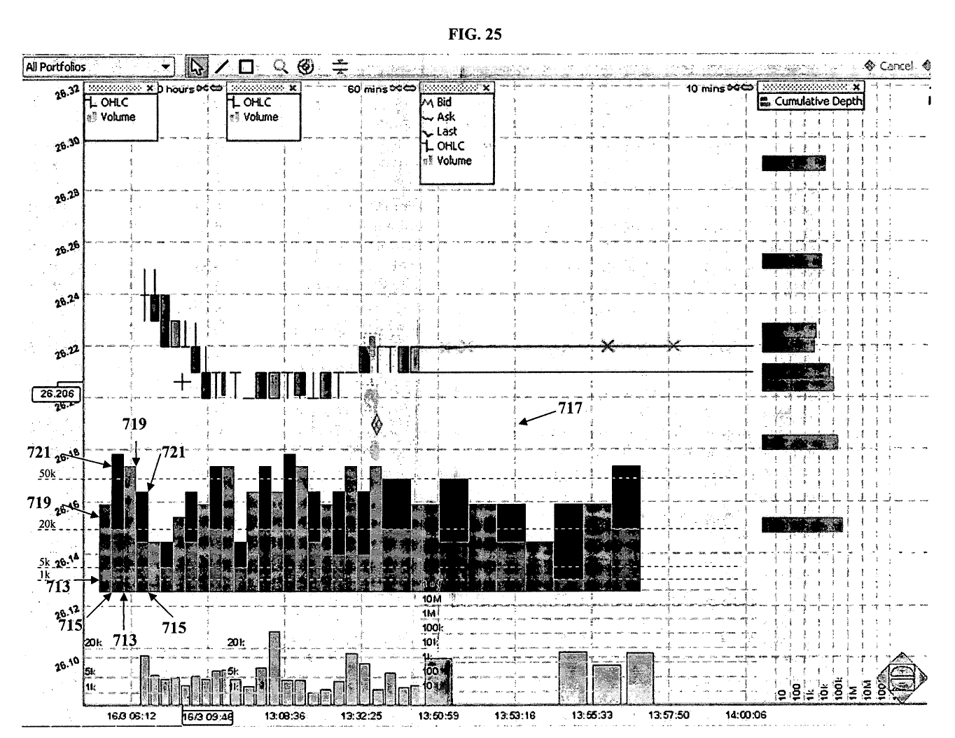

Referring to FIG. 24, for a particular predefined base point spread (b, herein) the average bid size is shown at 713 and the average ask size is shown at 715 of historical depth snapshot 712. Referring to FIG. 25, historical depth snapshot 717 shows additional bands 719 and 721 located on top of bands 713 and 715, respectively. Additional bands 719 and 721 are second bands with a price difference (b1, herein) greater than b of FIG. 24. Hence, the total height of the bands 713 plus 719 and of 715 plus 721 represent the average bid size or average ask size with a spread of b1. There is no limit to the number of base point spreads (b, b1, b2, b3 . . . bn) that can be shown as bands in a historical depth snapshot where b<b1<b2<b3 . . . <bn.

We claim:

1. A method for displaying on a graphical user interface at least one of stock and other equity type information for trade related actions by a user with an electronic exchange, said displaying being configurable by said user, comprising:
graphically displaying and updating in substantially real time in a first portion of said graphical user interface historical filled order data;
graphically displaying and updating in substantially real time in a second portion of said graphical user interface current unfilled order data;
graphically displaying said trade related actions made on said graphical user interface by said user; and
graphically displaying modifications made on said graphical user interface to said trade related actions by said user.

2. The method of claim 1 further comprising:
allowing variation by said user of physical dimension of at least one of said first portion and said second portion of said graphical user interface.

3. The method of claim 1 wherein said trade related actions are selected from the group consisting of placing a new order, replacing said new order with a second order, canceling said new order, and canceling a replaced order.

4. The method of claim 1 wherein said modifications to said trade related actions include replacing a new order, canceling a new order, and canceling a replaced order.

5. The method of claim 1 wherein said historical filled order data is selected from the group consisting of bid, ask and last prices.

6. The method of claim 1 wherein said unfilled order is selected from the group consisting of current, bid and ask prices.

7. The method of claim 2 wherein said variation of said physical dimension is selected from the group consisting of x-axis variation and y-axis variation.

8. A method for displaying on a graphical user interface at least one of stock and other equity type information for trade related actions by a user with an electronic exchange, said displaying being configurable by said user, comprising:
graphically displaying and updating in substantially real time in a first portion of said graphical user interface historical filled order data;
graphically displaying and updating in substantially real time in a second portion of said graphical user interface current unfilled order data;
graphically displaying said trade related actions made on said graphical user interface by said user;
graphically displaying modifications made on said graphical user interface to said trade related actions by said user; and
allowing variation by said user of physical dimension of at least one of said first portion and said second portion of said graphical user interface.

9. The method of claim 8 wherein said trade related actions are selected from the group consisting of placing a new order, replacing said new order with a second order, canceling said new order, and canceling a replaced order.

10. The method of claim 8 wherein said modifications to said trade related actions include replacing a new order, canceling a new order, and canceling a replaced order.

11. The method of claim 8 wherein said historical filled order data is selected from the group consisting of bid, ask and last prices.

12. The method of claim 8 wherein said unfilled order is selected from the group consisting of current, bid and ask prices.

13. The method of claim 8 wherein said variation of said physical dimension is selected from the group consisting of x-axis variation and y-axis variation.

14. A system for displaying on a graphical user interface at least one of stock and other equity type information for trade related actions by a user with an electronic exchange, said displaying being configurable by said user, comprising:
a component for graphically displaying and updating in substantially real time in a first portion of said graphical user interface historical filled order data;
a component for graphically displaying and updating in substantially real time in a second portion of said graphical user interface current unfilled order data;
a component for graphically displaying said trade related actions made on said graphical user interface by said user; and
a component for graphically displaying modifications made on said graphical user interface to said trade related actions by said user.

15. The system of claim 14 further comprising:
a component for allowing variation by said user of physical dimension of at least one of said first portion and said second portion of said graphical user interface.

16. The system of claim 14 wherein said trade related actions are selected from the group consisting of placing a new order, replacing said new order with a second order, canceling said new order, and canceling a replaced order.

17. The system of claim 14 wherein said modifications to said trade related actions include replacing a new order, canceling a new order, and canceling a replaced order.

18. The system of claim 14 wherein said historical filled order data is selected from the group consisting of bid, ask and last prices.

19. The system of claim 14 wherein said unfilled order is selected from the group consisting of current, bid and ask prices.

20. The system of claim 15 wherein said variation of said physical dimension is selected from the group consisting of x-axis variation and y-axis variation.

21. A system for displaying on a graphical user interface at least one of stock and other equity type information for trade related actions by a user with an electronic exchange, said displaying being configurable by said user, comprising:
a component for graphically displaying and updating in substantially real time in a first portion of said graphical user interface historical filled order data;
a component for graphically displaying and updating in substantially real time in a second portion of said graphical user interface current unfilled order data;
a component for graphically displaying said trade related actions made on said graphical user interface by said user;
a component for graphically displaying modifications made on said graphical user interface to said trade related actions by said user; and
a component for allowing variation by said user of physical dimension of at least one of said first portion and said second portion of said graphical user interface.

22. The system of claim 21 wherein said trade related actions are selected from the group consisting of placing a new order, replacing said new order with a second order, canceling said new order, and canceling a replaced order.

23. The system of claim 21 wherein said modifications to said trade related actions include replacing a new order, canceling a new order, and canceling a replaced order.

24. The system of claim 21 wherein said historical filled order data is selected from the group consisting of bid, ask and last prices.

25. The system of claim 21 wherein said unfilled order is selected from the group consisting of current, bid and ask prices.

26. The system of claim 21 wherein said variation of said physical dimension is selected from the group consisting of x-axis variation and y-axis variation.

27. A method for displaying on a graphical user interface at least one of stock and other equity type information for trade related actions by a user with an electronic exchange, said displaying being configurable by said user, comprising:
graphically displaying and updating in substantially real time in a first portion of said graphical user interface historical filled order data;
graphically displaying and updating in substantially real time in a second portion of said graphical user interface current unfilled order data;
graphically displaying said trade related actions made on said graphical user interface by said user;
graphically displaying modifications made on said graphical user interface to said trade related actions by said user; and
graphically displaying depth price bands denoting available volume at a particular price.

28. The method of claim 27 further comprising:
allowing variation by said user of physical dimension of at least one of said first portion and said second portion of said graphical user interface.

29. The method of claim 27 wherein said trade related actions are selected from the group consisting of placing a new order, replacing said new order with a second order, canceling said new order, and canceling a replaced order.

30. The method of claim 27 wherein said modifications to said trade related actions include replacing a new order, canceling a new order, and canceling a replaced order.

31. The method of claim 27 wherein said historical filled order data is selected from the group consisting of bid, ask and last prices.

32. The method of claim 27 wherein said unfilled order is selected from the group consisting of current, bid and ask prices.

33. The method of claim 28 wherein said variation of said physical dimension is selected from the group consisting of x-axis variation and y-axis variation.

34. A method for displaying on a graphical user interface at least one of stock and other equity type information for trade related actions by a user with an electronic exchange, said displaying being configurable by said user, comprising:
graphically displaying and updating in substantially real time in a first portion of said graphical user interface historical filled order data;
graphically displaying and updating in substantially real time in a second portion of said graphical user interface current unfilled order data;
graphically displaying said trade related actions made on said graphical user interface by said user;
graphically displaying modifications made on said graphical user interface to said trade related actions by said user; and
graphically displaying historical depth of market information denoting previously available volume at a particular price.

35. The method of claim 34 wherein said trade related actions are selected from the group consisting of placing a new order, replacing said new order with a second order, canceling said new order, and canceling a replaced order.

36. The method of claim 34 wherein said modifications to said trade related actions include replacing a new order, canceling a new order, and canceling a replaced order.

37. The method of claim 34 wherein said historical filled order data is selected from the group consisting of bid, ask and last prices.

38. The method of claim 34 wherein said unfilled order is selected from the group consisting of current, bid and ask prices.

39. The method of claim 34 wherein said variation of said historical depth of market information is selected from the group consisting of periodic data, simple average data, weighted average data, and min-max-open-close data.

40. A system for displaying on a graphical user interface at least one of stock and other equity type information for trade related actions by a user with an electronic exchange, said displaying being configurable by said user, comprising:
a component for graphically displaying and updating in substantially real time in a first portion of said graphical user interface historical filled order data;
a component for graphically displaying and updating in substantially real time in a second portion of said graphical user interface current unfilled order data;
a component for graphically displaying said trade related actions made on said graphical user interface by said user;
a component for graphically displaying modifications made on said graphical user interface to said trade related actions by said user; and
a component for graphically displaying depth price bands denoting available volume at a particular price.

41. The system of claim 40 further comprising:
a component for allowing variation by said user of physical dimension of at least one of said first portion and said second portion of said graphical user interface.

42. The system of claim 40 wherein said trade related actions are selected from the group consisting of placing a new order, replacing said new order with a second order, canceling said new order, and canceling a replaced order.

43. The system of claim 40 wherein said modifications to said trade related actions include replacing a new order, canceling a new order, and canceling a replaced order.

44. The system of claim 40 wherein said historical filled order data is selected from the group consisting of bid, ask and last prices.

45. The system of claim 40 wherein said unfilled order is selected from the group consisting of current, bid and ask prices.

46. The system of claim 41 wherein said variation of said physical dimension is selected from the group consisting of x-axis variation and y-axis variation.

47. A system for displaying on a graphical user interface at least one of stock and other equity type information for trade related actions by a user with an electronic exchange, said displaying being configurable by said user, comprising:
a component for graphically displaying and updating in substantially real time in a first portion of said graphical user interface historical filled order data;
a component for graphically displaying and updating in substantially real time in a second portion of said graphical user interface current unfilled order data;
a component for graphically displaying said trade related actions made on said graphical user interface by said user;
a component for graphically displaying modifications made on said graphical user interface to said trade related actions by said user; and
a component for graphically displaying historical depth of market information denoting previously available volume at a particular price.

48. The system of claim 47 wherein said trade related actions are selected from the group consisting of placing a new order, replacing said new order with a second order, canceling said new order, and canceling a replaced order.

49. The system of claim 47 wherein said modifications to said trade related actions include replacing a new order, canceling a new order, and canceling a replaced order.

50. The system of claim 47 wherein said historical filled order data is selected from the group consisting of bid, ask and last prices.

51. The system of claim 47 wherein said unfilled order is selected from the group consisting of current, bid and ask prices.

52. The system of claim 47 wherein said historical depth of market information is selected from the group consisting of periodic data, simple average data, weighted average data, and min-max-open-close data.
